(19) United States
(12) Patent Application Publication
(10) Pub. No.: US 2004/0127361 A1
(43) Pub. Date: Jul. 1, 2004

(54) Pyridinyl fused bicyclic amides as fungicides

(76) Inventor: Ying Song, Hockessin, DE (US)

Correspondence Address: David E Heiser, E I Du Pont De Nemours and Company, Legal-Patents, Wilmington, DE, 19898, US

(21) Appl. No.: 10/473,700

(22) PCT Filed: May 14, 2002
(86) PCT No.: PCT/US02/18394

(51) Int. Cl. A01N 25/26; A01N 43/42

(52) U.S. Cl. 504/100; 514/311; 514/300

(57) ABSTRACT

This invention involves a method for controlling plant diseases caused by fungal plant pathogens comprising applying to the plant or portion thereof, or to the plant seed or seedling, a fungicidally effective amount of a compound of Formula I (including all geometric and stereoisomers), N-oxides, agriculturally suitable salts and compositions thereof, wherein A is taken together with N—C═C to form a substituted fused pyridinyl ring; B is a substituted phenyl or pyridinyl ring; J is an optionally substituted linking chain of 2 to 5 members including at least one carbon member, optionally including one or two carbon members as C(═O), and optionally including one member selected from nitrogen and oxygen;W is C=L or SOₙ; L is O or S;R₁ is H; or C₁-C₆ alkyl, C₂-C₆ alkenyl, C₂-C₆ alkynyl or C₃-C₆ cycloalkyl, each optionally substituted;R₃ is H; or C₁-C₆ alkyl, C₂-C₆ alkenyl, C₂191-C₆ alkynyl or C₃-C₆ cycloalkyl, C₂-C₆ alkylcarbonyl, C₂-C₆ alkoxycarbonyl, C₂-C₆ alkylaminocarbonyl or C₃-C₈ dialkylaminocarbonyl; and n is 1 or 2. This invention also includes fungicidal compositions comprising a compound of Formula I, N-oxides, and agriculturally suitable salts thereof. This invention also includes compounds of Formula I,N-oxides and agriculturally suitable salts thereof, provided that when B is a substituted phenyl ring, W is C═O or SO₂, R₃ is H and J is a saturated chain of from 2 to 4 carbons that is either unsubstituted or substituted with one to three substituents selected from the group consisting of alkyl, alkoxy, aryl or aralkyl, then the compounds are N-oxides.

### BACKGROUND OF THE INVENTION

This invention relates to certain bicyclic amides having a pyridinyl ring fused through two adjacent carbon atoms to a second ring, their N-oxides, agriculturally suitable salts and compositions, and methods of their use as fungicides.

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new compounds, which are more effective, less costly, less toxic, environmentally safer or have different modes of action.

WO 99/42447 discloses certain benzamides of formula i as fungicides

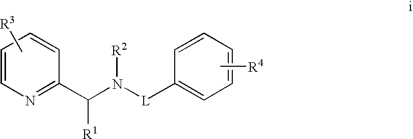

wherein (among others) R¹ is H, alkyl, or acyl; R² is H or alkyl; and L is —C═O)—, —SO₂— or —(C═S)—.

GB 2219797 discloses certain fused pyridinyl compounds of Formula ii

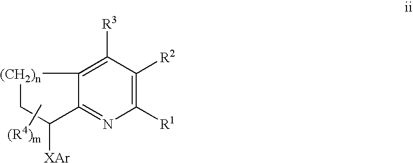

wherein (among others) X is NHCO or NHSO₂; Ar is an optionally substituted phenyl; R⁴ is alkyl, alkoxy, aryl or aralkyl; m is 1, 2 or 3 and n is 1, 2 or 3.

Agents that effectively control plant fungi, particularly of the class Oomycetes, such as Phytophthora spp. and Plasmropara spp., are in constant demand by growers. Combinations of fungicides are often used to facilitate disease control and to retard resistance development. It is desirable to enhance the activity spectrum and the efficacy of disease control by using mixtures of active ingredients that provide a combination of curative, systemic and preventative control of plant pathogens. Also desirable-are combinations that provide greater residual control to allow for extended spray intervals. It is also very desirable to combine fungicidal agents that inhibit different biochemical pathways in the fungal pathogens to retard development of resistance to any one particular plant disease control agent.

It is in all cases particularly advantageous to be able to decrease the quantity of chemical agents released in the environment while ensuring effective protection of crops from diseases caused by plant pathogens. Mixtures of fungicides may provide significantly better disease control than could be predicted based on the activity of the individual components. This synergism has-been described as “the cooperative action of two components of a mixture, such that the total effect is greater or more prolonged than the sum of the effects of the two (or more) taken independently” (see Tames, P. M. L., Neth. J. Plant Pathology, (1964), 70, 73-80).

There is a desire to find fungicidal agents that are particularly advantageous in achieving one or more of the preceding objectives.

### SUMMARY OF THE INVENTION

This invention involves compounds of Formula I (including all geometric and stereoisomers), N-oxides, agriculturally suitable salts and compositions thereof:

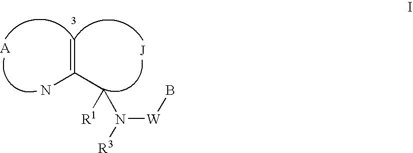

wherein

A is taken together with N—C═C to form a substituted fused pyridinyl ring;

B is a substituted phenyl or pyridinyl ring;

J is an optionally substituted linking chain of 2 to 5 members including at least one carbon member, optionally including one or two carbon members as C(═O), and optionally including one member selected from nitrogen and oxygen;

W is C=L or SOₙ;

L is O or S;

R₁ is H; or C₁-C₆ alkyl, C₂-C₆ alkenyl, C₂-C₆ alkynyl or C₃-C₆ cycloalkyl, each optionally substituted;

R³ is H; or C₁-C₆ alkyl, C₂-C₆ alkenyl, C₂-C₆ alkynyl or C₃-C₆ cycloalkyl, C₂-C₆ alkylcarbonyl, C₂-C₆ alkoxycarbonyl, C₂-C₆ alkylaminocarbonyl or C₃-C₈ dialkylaminocarbonyl; and

n is 1 or 2.

In particular, this invention includes a method for controlling plant diseases caused by fungal plant pathogens comprising applying to the plant or portion thereof, or to the plant seed or seedling, a fungicidally effective amount of a compound of Formula I (including all geometric and stereoisomers, N-oxides and agriculturally suitable salts thereof) or a composition comprising said compound.

This invention also includes compounds of Formula I (including all geometric and stereoisomers), N-oxides and agriculturally suitable salts thereof, provided that when B is a substituted phenyl ring, W is C═O or SO₂, R³ is H and J is a saturated chain of from 2 to 4 carbons that is either unsubstituted or substituted with from one to three substituents selected from the group consisting of alkyl alkoxy, aryl or aralkyl, then the compounds are N-oxides.

This invention also includes fungicidal compositions comprising (1) a fungicidally effective amount of a compound of Formula I (including all geometric and stereoisomers, N-oxides and agriculturally suitable salts thereof); and (2) (i) at least one other insecticide, fungicide, nematocide, bactericide, acaricide, growth regulator, chemosterilant, semiochemical, repellent, attractant, pheromone, feeding stimulant or other biologically active compound; and/or (ii) at least one additional component selected from the group consisting of surfactants, solid diluents and liquid diluents.

This invention provides, for example, compositions comprising (a) at least one compound of Formula I; and

(b) at least one compound selected from the group consisting of

(b1) alkylenebis(dithiocarbamate) fungicides;

(b2) compounds acting at the bc₁ complex of the fungal mitochondrial respiratory electron transfer site;

(b3) cymoxanil;

(b4) compounds acting at the demethylase enzyme of the sterol biosynthesis pathway;

(b5) morpholine and piperidine compounds that act on the sterol biosynthesis pathway;

(b6) phenylamide fungicides;

(b7) pyrimidinone fungicides;

(b8) phthalimides; and

(b9) fosetyl-aluminum.

### DETAILS OF THE INVENTION

As noted above, A is a substituted fused pyridinyl ring and B is a substituted phenyl or pyridinyl ring. The term “substituted” in connection with these A or B rings refers to groups that have at least one non-hydrogen substituent that does not extinguish the fungicidal activity. Examples of Formula I incorporating said A and B rings in which A is substituted with one or two substituents selected from R⁵ and B is substituted with from one to three substituents selected from R⁶ include the rings illustrated in Exhibit 1 wherein m is an integer from 1 to 2 and p is an integer from 1 to 3. Note that the attachment point between (R⁵)ₘ and A and (R⁶)ₚ and B is illustrated as floating, and (R⁵)ₘ and (R⁶)ₚ can be attached to any available carbon atom of the phenyl or pyridinyl rings.

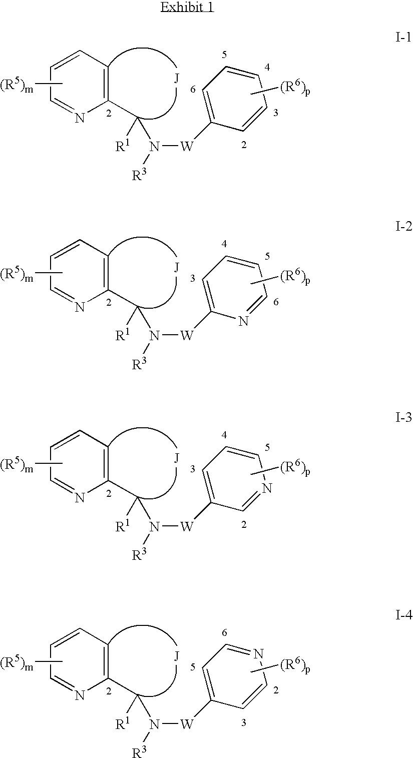

Examples of R⁵ when attached to A and R⁶ when attached to B include

each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁵ and each R⁶ is independently a phenyl ring, a 5- or 6-membered heteroaromatic ring, a benzyl ring or a phenoxy ring, each ring optionally substituted with from one to three groups independently selected from R⁷;

each R⁷ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl C₁-C₄ alkoxycarbonyl C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl C₂-C₆ alkylaminocarbonyl, C₃-C₈ dialkylaminocarbonyl or C₃-C₆ trialkylsilyl.

As noted above, R¹ can be (among others) C₁-C₆ alkyl, C₂-C₆ alkenyl C₂-C₆ alkynyl or C₃-C₆ cycloalkyl, each optionally substituted. The term “optionally substituted” in connection with these R¹ groups refers to R¹ groups that are unsubstituted or have at least one non-hydrogen substituent that does not extinguish the fungicidal activity possessed by the unsubstituted analog. Examples of optionally substituted R¹ groups are those that are optionally substituted by replacement of a hydrogen on a carbon atom of the R¹ group with one or more (up to the total number of hydrogens available for replacement in any specific R¹ group) substituents independently selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylamino and C₃-C₆ cycloalkylamino. Although these substituents are listed in the examples above, it is noted that they do not need to be present since they are optional substituents. Of note are R¹ groups optionally substituted with from one to five substituents.

Examples of N-oxides of Formula I are illustrated as I-5 through I-10 in Exhibit 2, wherein R¹, R³, R⁵, R⁶, W, m and p are as defined above.

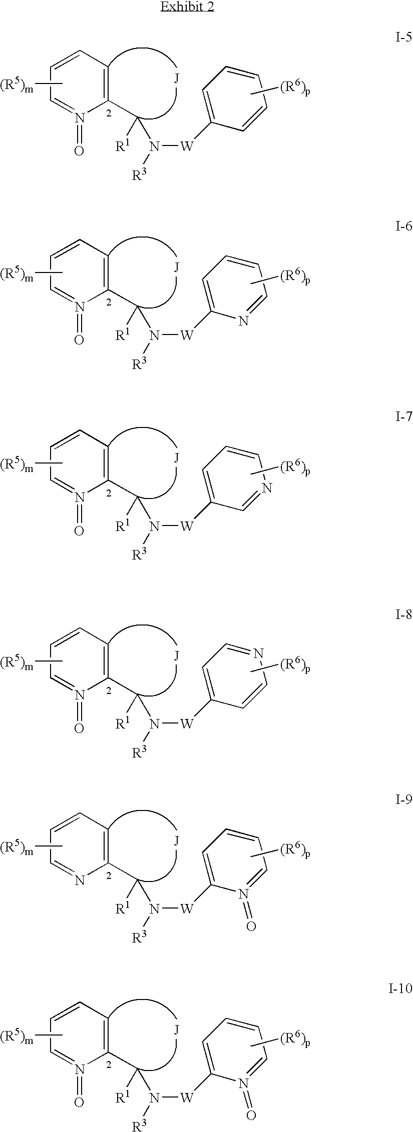

As noted above, each R⁵ and each R⁶ can be (among others) a phenyl ring, a 5- or 6-membered heteroaromatic ring, a benzyl ring or a phenoxy ring, each ring optionally substituted with from one to three groups independently selected from R⁷. The term “optionally substituted” in connection with these groups refers to groups which are unsubstituted or have at least one non-hydrogen substituent that does not extinguish the biological activity possessed by the unsubstituted analog. An example of a phenyl ring optionally substituted with one to three groups independently selected from R⁷ is the ring illustrated as R^{x}-56 in Exhibit 3, wherein x is either 5 or 6 and r is an integer from one to three. Examples of 5- or 6-membered heteroaromatic rings optionally substituted with one to three groups independently selected from R⁷ include the rings R^{x}-1 through R^{x}-55 illustrated in Exhibit 3, wherein x is either 5 or 6 and r is an integer from one to three. An example of a benzyl ring optionally substituted with one to three groups independently selected from R⁷ is the ring illustrated as R^{x}-57 in Exhibit 3, wherein x is either 5 or 6 and r is an integer from one to three. An example of a phenoxy ring optionally substituted with one to three groups independently selected from R⁷ is the ring illustrated as R^{x}-58 in Exhibit 3, wherein x is either 5 or 6 and r is an integer from one to three.

Although one to three R⁷ groups (represented as (R⁷)ᵣ) are show in the structures of R^{x}-1 through R^{x}-58, it is noted that they do not need to be present since they are optional substituents. The nitrogen atoms that require substitution to fill their valence are substituted with H or R⁷. Note that some Rx groups can only be substituted with less than three R⁷ groups (e.g. R^{x}-15, R^{x}-16, R^{x}-17 through R^{x}-20 and R^{x}-31 through R^{x}-33 can only be substituted with one R⁷). Note that when the attachment point between (R⁷)ᵣ and the R^{x} group is illustrated as floating, (R⁷)ᵣ can be attached to any available carbon atom of the R^{x} group.

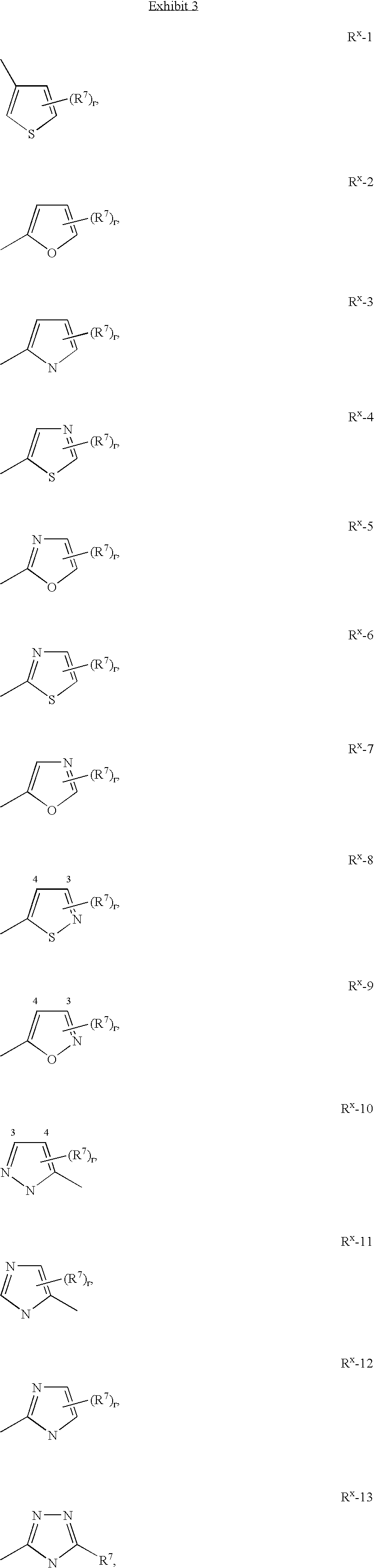

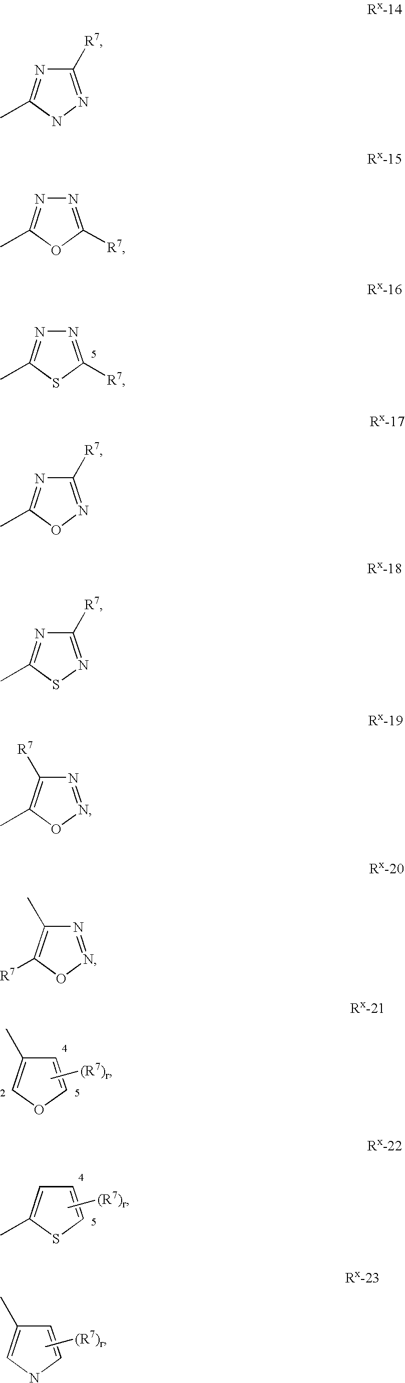

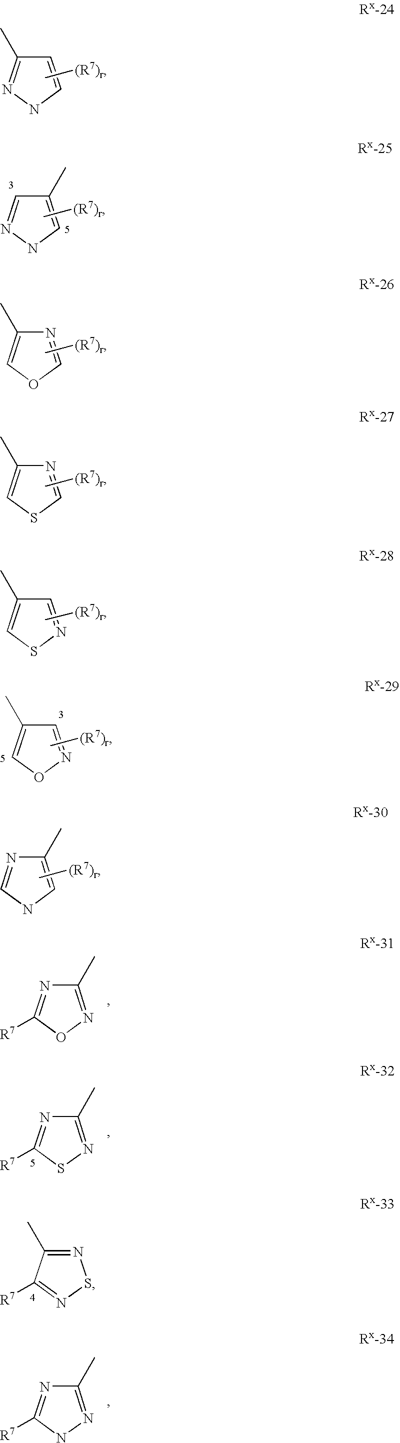

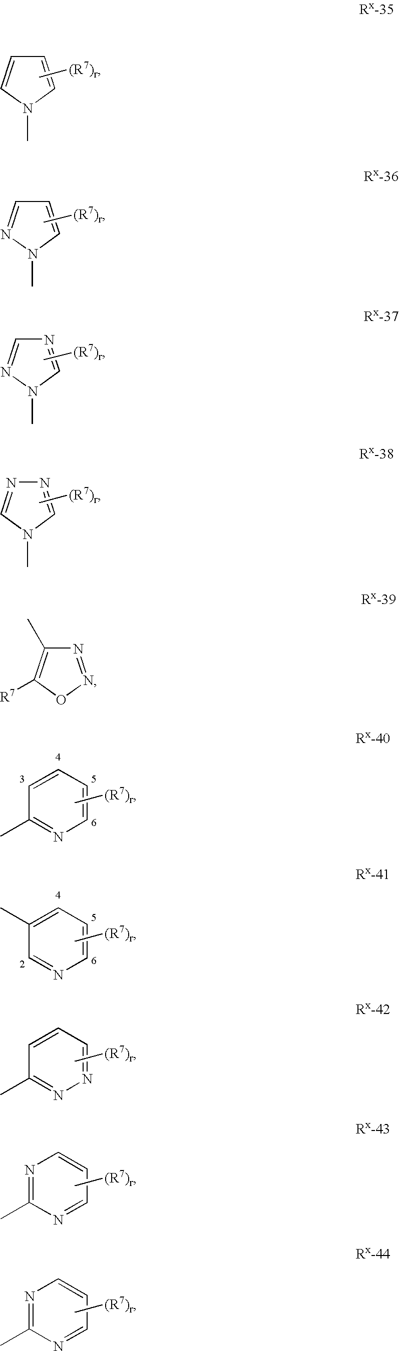

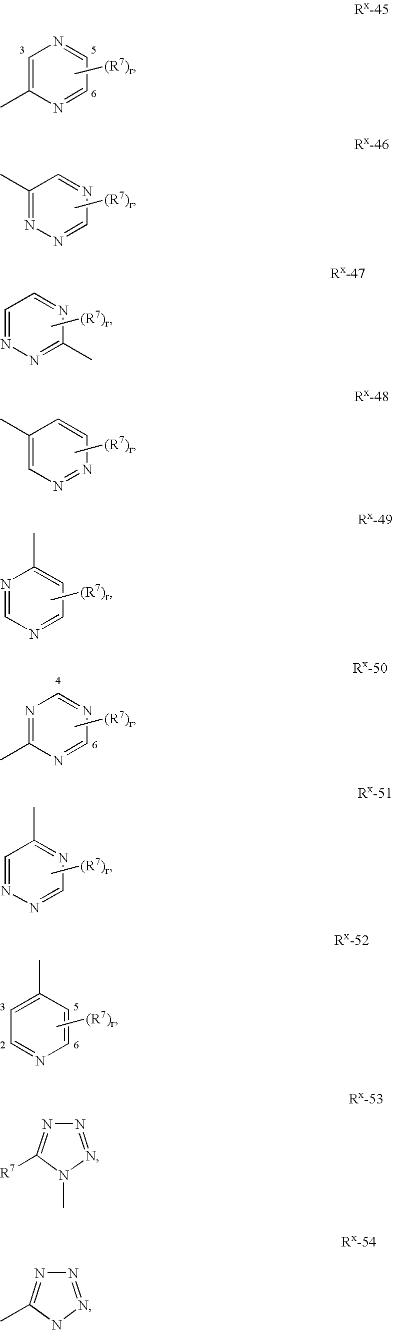

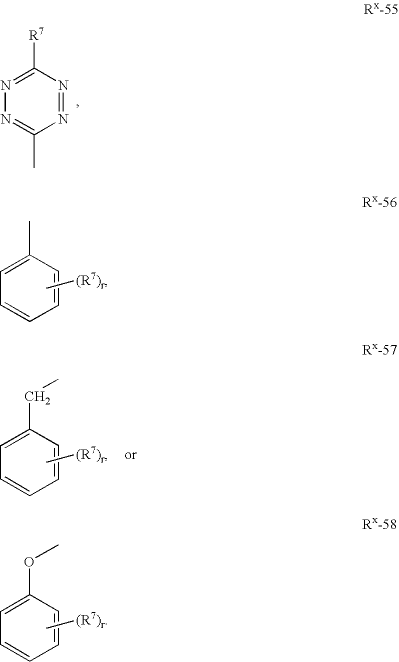

As noted above, J is an optionally substituted linking chain of 2 to 5 members including at least one carbon member, optionally including one or two carbon members as C(═O), and optionally including one member selected from nitrogen and oxygen. The term “optionally substituted” in connection with the linking chain J refers to J-groups which are unsubstituted or have at least one non-hydrogen substituent that does not extinguish the biological activity possessed by the unsubstituted analog. Examples of optionally substituted J-groups include the J-groups illustrated in Exhibit 4. The J-groups in Exhibit 4 are illustrated such that the left end of the J-group is attached to the A-ring at the 3-position and the right end of the J-group is attached to the carbon atom bearing the N(R³)WB moiety.

The J-groups in Exhibit 4 can be optionally substituted by replacement of a hydrogen on a carbon atom or nitrogen atom of the J-group with one or more (up to the total number of hydrogens available for replacement in any specific J-group) substituents independently selected from the group consisting of C₁-C₂ alkyl, halogen, CN, NO₂ and C₁-C₂ alkoxy. Although these substituents are listed, it is noted that they do not need to be present since they are optional substituents. Of note are J-groups optionally substituted with from one to four substituents selected from the group above.

### Exhibit 4

Exhibit 4

| | | |
|---|---|---|
| —CH₂CH₂— | —OCH₂— | —NHCH₂— |
| —CH₂CH₂CH₂— | —OCH₂CH₂— | —N(C₁—C₂alkyl)CH₂— |
| —CH₂CH₂CH₂CH₂— | —OCH₂CH₂CH₂— | —NHCH₂CH₂— |
| —CH₂CH₂CH₂CH₂CH₂— | —CH₂OCH₂— | —N(C₁—C₂alkyl)CH₂CH₂— |
| —C(═O)NHC(═O)— | —CH₂OC(═O)— | —CH₂NHCH₂— |
| —C(═O)N(C₁—C₂alkyl)C(═O)— | —CH₂CH₂OC(═O)— | —CH₂N(C₁—C₂alkyl)CH₂— |
| —CH₂N(C₁—C₂alkyl)C(═O)— | —CH₂NHC(═O)— | |
| —CH₂CH₂N(C₁—C₂alkyl)C(═O)— | —CH₂CH₂NHC(═O)— | |

In the above recitations, the term “alkyl”, used either alone or in compound words such as “alkylthio” or “haloalkyl” includes straight-chain or branched alkyl, such as methyl, ethyl, n-propyl, i-propyl, or the different butyl, pentyl or hexyl isomers. “Alkenyl” includes straight chain or branched alkenes such as ethenyl, 1-prop enyl, 2-propenyl, and the different butenyl, pentenyl and hexenyl isomers. “Alkenyl” also includes polyenes such as 1,2-propadienyl and 2,4-hexadienyl. “Alkynyl” includes straight chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkylthio” includes branched or straight chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(O), CH₃CH₂S(O), CH₃CH₂CH₂S(O), (CH₃)₂CHS(O) and the different butylsulfinyl pentylsulfinyl and hexylsulfinyl isomers. Examples of “alkylsulfonyl” include CH₃S(O)₂, CH₃CH₂S,(O)₂, CH₃CH₂CH₂S(O)₂, (CH₃)₂CHS(O)₂ and the different butylsulfonyl, pentylsulfonyl and hexylsulfonyl isomers. “Alkylamino”, “dialkylamino” and the like, are defined analogously to the above examples. “Cycloalkyl” includes, for example, cyclopropyl, cyclobutyl, cyclopentyl and cyclohexyl.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, “haloalkylthio”, and the like, are defined analogously to the term “haloalkyl”. Examples of “haloalkenyl” include (Cl)₂C═CHCH₂ and CF₃ CH₂CH═CHCH₂. Examples of “haloalkynyl” include HC≡CCHCl, CF₃C≡C, CCl₃C≡C and FCH₂C═CCH₂. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S. Examples of “haloalkylsulfinyl” include CF₃S(O), CCl₃S(O), CF₃CH₂S(O) and CF₃CF₂S(O). Examples of “haloalkylsulfonyl” include CF₃S(O)₂, CCl₃S(O)₂, CF₃CH₂S(O)₂ and CF₃CF₂S(O)₂.

Examples of “alkylcarbonyl” include CH₃C(═O), CH₃CH₂C(═O), CH₃CH₂CH₂C(═O) and (CH₃)₂CHC(═O). Examples of “alkoxycarbonyl” include CH₃NHC(═O), CH₃CH₂NHC(═O), CH₃CH₂CH₂° C.(═O), (CH₃)₂CHOC(—O) and the different butoxy- or pentoxycarbonyl isomers. Examples of “alkylaminocarbonyl” include CH₃NHC(═O), CH₃CH₂NHC(═O), CH₃CH₂CH₂NHC(═O), (CH₃)₂CHNHC(—O) and the different butylamino- or pentylamincarbonyl isomers. Examples of “dialkylaminocarbonyl” include (CH₃)₂NC(═O), (CH₃CH₂)₂NC(═O), CH₃CH₂(CH₃)NC(═O), CH₃CH₂CH₂(CH₃)NC(═O), (CH₃)₂CHN(CH3)C(═O) and the different butylamino- or pentylamincarbonyl isomers.

“Aromatic” indicates that each of the ring atoms is essentially in the same plane and has a p-orbital perpendicular to the ring plane, and in which (4n+2)π electrons, when n is 0 or a positive integer, are associated with the ring to comply with Hückel's rule. The term “hetero” in connection with rings refers to a ring in which at least one ring atom is not carbon and which can contain 1 to 4 heteroatoms independently selected from the group consisting of nitrogen, oxygen and sulfur, provided that each ring contains, no more than 4 nitrogens, no more than 2 oxygens and no more than 2 sulfurs. The terms “heteroaromatic ring” includes fully aromatic heterocycles. The heterocyclic ring can be attached through any available carbon or nitrogen by replacement of a hydrogen on said carbon or nitrogen. The term “aryl” refers to aromatic hydrocarbon moieties including phenyl, tolyl and naphthalenyl which may be optionally substituted. The term “aralkyl” is an alkyl moiety substituted with an aryl moiety including phenylalkyls such as benzyl (which may be optionally substituted).

One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R Katritzky and A. J. Boulton, Eds., Academic Press.

The total number of carbon atoms in a substituent group is indicated by the “Cᵢ—Cⱼ” prefix where i and j are numbers from 1 to 8. For example, C₁-C₃ alkylsulfonyl designates methylsulfonyl through propylsulfonyl; C₂-C₈ dialkylamino designates, for example, (CH₃)₂N, (CH₃CH₂)₂N, CH₃CH₂(CH₃)N, CH₃CH₂CH₂(CH₃)N or (CH₃)₂CHN(CH₃) containing a total of from 2 to 8 carbon atoms.

When a compound is substituted with a substituent bearing a subscript that indicates the number of said substituents can exceed 1, said substituents (when they exceed 1) are independently selected from the group of defined substituents. Further, when the subscript indicates a range, e.g. (R)ᵢ₋ⱼ, then the number of substituents may be selected from the integers between i and j inclusive.

The term “optionally substituted with from one to three substituents” and the like indicates that from one to three of the available positions on the group may be substituted. When a group contains a substituent which can be hydrogen, for example R¹ or R² then, when this substituent is taken as hydrogen, it is recognized that this is equivalent to said group being unsubstituted.

Compounds involved in this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the present invention comprises compounds selected from Formula I, N-oxides and agriculturally suitable salts thereof. The compounds may be present as a mixture of stereoisomers, individual stereoisomers, or as an optically active form. In particular, since R¹ and J of Formula I are different, then said formula possesses a chiral center at the carbon to which they are commonly bonded. This invention comprises racemic mixtures of equal parts of Formula I′ and Formula I″.

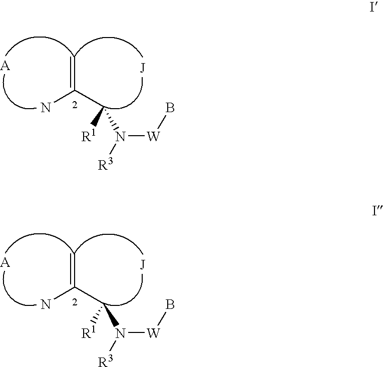

wherein A, B, J, W, R¹, R², and R³ are as defined above.

In addition, this invention includes compounds and compositions that are enriched in an enantiomer of the Formula I′ or Formula I″ compared to the racemic mixture. Included are compounds and compositions involving the essentially pure enantiomers of Formula I′ or Formula I″. For example, this invention includes compounds of Formula I that are enriched in an enantiomer of the Formula I′ compared to the racemic mixture. Included are the essentially pure enantiomers of Formula I′. This invention also includes compositions wherein component (a) is enriched in a component (a) enantiomer of Formula I″ compared to the racemic mixture. This invention also includes compounds of Formula I that are enriched in an enantiomer of the Formula I″ compared to the racemic mixture. Included are the essentially pure enantiomers of Formula I″. This invention also includes compositions wherein component (a) is enriched in a component (a) enantiomer of Formula I″ compared to the racemic mixture.

When enantiomerically enriched, one enantiomer is present in greater amounts than the other and the extent of enrichment can be defined by an expression of enantiomer excess (“ee”), which is defined as 100(2x−1) where x is the mole fraction of the dominant enantiomer in the mixture. (e.g., an ee of 20% corresponds to a 60:40 ratio of enantiomers). Preferably there is at least a 50% enantiomeric excess; more preferably at, least a 75% enantiomeric excess; still more preferably at least a 90% enantiomeric excess; and the most preferably at least a 94% enantiomeric excess of the more active isomer. Of particular note are enantiomerically pure embodiments of the more active isomer.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. The salts of the compounds of the invention also include those formed with organic bases (e.g., pyridine, ammonia, or triethylamine) or inorganic bases (e.g., hydrides, hydroxides, or carbonates of sodium, potassium, lithium, calcium, magnesium or barium) when the compound contains an acidic group such as a carboxylic acid or phenol.

This invention provides a method for controlling plant diseases caused by fungal plant pathogens comprising applying to the plant or portion thereof, or to the plant seed or seedling, a fungicidally effective amount of a compound of Formula I including all geometric and stereoisomers, IV-oxides and agriculturally suitable salts thereof (e.g. as a component of a composition described herein).

Preferred methods for reasons of better activity and/or ease of synthesis are:

Preferred 1. Preferred are methods comprising compounds of Formula I wherein

A is taken together with N—C═C to form a fused pyridinyl ring substituted with one or two substituents independently selected from R⁵;

B is substituted with from one to three substituents independently selected from R⁶;

J is a linking chain of 2 to 5 members including at least one carbon member, optionally including one or two carbon members as C(═O), and optionally including one member selected from nitrogen or oxygen, optionally substituted with one or more substituents selected from the group consisting of C₁-C₂ alkyl, halogen, CN, NO₂ and C₁-C₂ alkoxy;

R¹ is H; or C₁-C₆ alkyl, C₂-C₆ alkenyl C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylamino and C₃-C₆ cycloalkylamino;

each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ f-alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁵ and each R⁶ is independently a phenyl ring, a 5- or 6-membered heteroaromatic ring, a benzyl ring or a phenoxy ring, each ring optionally substituted with from one to three groups independently selected from R⁷; and

each R⁷ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl C₁-C₄ alkoxycarbonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl.

Of note are methods of Preferred 1 wherein

each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl C₁-C₄ haloalkylsulfonyl, C₁-C₄ alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl C₃-C₆ trialkylsilyl; or

each R⁵ and each R⁶ is independently phenyl benzyl or phenoxy, each optionally substituted with C₁-C₄ alkyl, C₂-C₄ alkenyl C₂-C₄ alkynyl, C₃-C₆ cycloalkyl C₁-C₄ haloalkyl, C₂-C₄ haloalkenyl, C₂-C₄ haloalkynyl C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl C₁-C₄ alkoxycarbonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl.

Preferred 2. Methods of Preferred 1 wherein W is C—O.

Preferred 3. Methods of Preferred 2 wherein

J is selected from —CH₂CH₂—, —CH₂CH₂CH₂—, —CH₂CH₂CH₂CH₂—, —OCH₂—, —OCH₂CH₂—, —OCH₂CH₂CH₂—, —CH₂NHCH₂—, —CH₂N(C₁-C₂ alkyl)CH₂—, —CONHCO— and —CON(C₁-C₂ alkyl)CO—; and

each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkoxycarbonyl, C₂-C₆ alkylcarbonyl, C₂-C₆ alkoxycarbonyl, C₂-C₆ alkylaminocarbonyl or C₃-C₈ dialkylaminocarbonyl.

Preferred 4. Methods of Preferred 3 wherein each R⁵ is independently halogen, CN, NO₂, C₁-C₂ alkyl, C₁-C₂ haloalkyl, C₁-C₂ alkoxy, C₁-C₂ haloalkoxy, C₁-C₂ alkylthio, C₁-C₂ alkylsulfinyl and C₁-C₂ alkylsulfonyl, C₁-C₂ haloalkylthio, C₁-C₂ haloalkylsulfinyl C₁-C₂ haloalkylsulfonyl, C₂-C₄ alkoxycarbonyl or C₂-C₄ alkylaminocarbonyl.

Of note are methods of Preferred 4 wherein R⁵ is CH₃, Cl, Br, I, CN, NO₂, CF₃, CO₂CH₃, CONHCH₃CH₃, OCF₃, OCHF₂, OCH₂CF₃, OCF₂CF₃, OCF₂CF₂H, OCHFCF₃, SCF₃, SCHF₂, SCH₂CF₃, SCF₂CF₃, SCF₂CF₂H, SCHFCF₃, SOCF₃, SOCHF₂, SOCH₂CF₃, SOCF₂CF₃, SOCF₂CF₂H, SOCHFCF₃, SO₂CF₃, SO₂CHF₂, SO₂CH₂CF₃, SO₂CF₂CF₃, SO₂CF₂CF₂H or SO₂CHFCF₃.

Preferred 5. Methods of Preferred 4 wherein B is a phenyl ring optionally substituted with from one to three substituents independently selected from R⁶.

Preferred 6. Methods of Preferred 5 wherein each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

Of note are methods of Preferred 6 wherein there is an R⁶ at each position ortho to the link with W, and optionally 1 to 2 additional R⁶ and R⁶ is either halogen or methyl.

Preferred 7. Methods of Preferred 6 wherein J is —CH₂CH₂— or —CH₂CH₂CH₂—.

Preferred 8. Methods of Preferred 7 wherein each R⁵ is independently CH₃, Cl, Br, I, CN, NO₂, CF₃, OCF₃, OCHF₂, SCF₃, SCHF₂, CO₂CH₃ or CONHCH₃.

Of note are methods of Preferred 8 wherein R⁵ is CH₃, Cl, Br, CN, NO₂, CF₃, CO₂CH₃ or CONHCH₃.

Preferred 9. Methods of Preferred 4 wherein B is a 3-pyridinyl or a 4-pyridinyl ring optionally substituted with from one to three substituents independently selected from R⁶.

Preferred 10. Methods of Preferred 9 wherein each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

Preferred 11. Methods of Preferred 10 wherein I is —CH₂CH₂— or —CH₂CH₂CH₂—.

Preferred 12. Methods of Preferred 11 wherein each R⁵ is independently CH₃, Cl, Br, I, CN, NO₂, CF₃, OCF₃, OCHF₂, SCF₃, SCHF₂, CO₂CH₃ or CONHCH₃.

Of note are methods of Preferred 12 wherein R⁵ is CH₃, Cl, Br, CN, NO₂, CF₃, CO₂CH₃ or CONHCH₃.

Preferred 13. Methods of Preferred 12 wherein B is a 3-pyridinyl ring wherein one R⁶ is Cl located at the 2-position ortho to the link with C═O, another R⁶ is selected from Cl or methyl and is located at the 4-position ortho to the link with C═O and a third optional R⁶ is methyl at the 6-position.

Preferred 14. Methods of any of Preferred 2 through Preferred 13 wherein R¹ is H and R³ is H.

Specifically preferred are the methods comprising a compound selected from the group consisting of

2-chloro-6-methoxy-N-(5,6,7,8-tetrahydro-3-methyl-8-quinolinyl)₄-pyridinecarboxamide,

2,6-dichloro-N-(5,6,7,8-tetrahydro-3-methyl-8-quinolinyl)benzamide and

2,3,6-trifluoro-N-(5,6,7,8-tetrahydro-3-methyl-8-quinolinyl)benzamide.

This invention also relates to fungicidal compositions comprising fungicidally effective amounts of the compounds of Formula I. The preferred compositions of the present invention are those which comprise the compounds recited in Preferred 1 through Preferred 14 above.

This invention also includes compounds of Formula I including all geometric and stereoisomers, N-oxides and agriculturally suitable salts thereof, provided that when B is a substituted phenyl ring, W is C═O or SO₂, R³ is H and J is a saturated chain of from 2 to 4 carbons that is either unsubstituted or substituted with from one to three substituents selected from the group consisting of alkyl, alkoxy, aryl or aralkyl, then the compounds are N-oxides. Preferred compounds are those recited in Preferred 1 through Preferred 14 above, subject to the proviso above.

A specifically preferred compound is 2-chloro-6-methoxy-N-(5,6,7,8-tetrahydro-3-methyl-8-quinolinyl)₄-pyridinecarboxamide.

The compounds of Formula I can be prepared by one or more of the following methods and variations as described in Schemes 1-19. Compounds of Formulae Ia, Ib and Ic are subsets of the compounds of Formula I, and all substituents for Formulae Ia, Ib and Ic are as defined above for Formula I. The definitions of A, B, J. L, W. R¹ through R⁶ and min the compounds of Formulae 1-19 below are as defined above. Compounds of Formula Ia-e, 6a-c, 8a-f, 10a-c, 11a-c, 16a-b, 18a-d and 19a-b are subsets of Formula 1, 6, 8, 10, 11, 16, 18 and 19 respectively. J¹ through J⁶ in the formulae below are subsets of J.

As illustrated in Scheme 1, the compounds of Formula Ia are prepared by treating amine or amine salts of Formula 1 with an appropriate acid chloride in an inert solvent with two molar equivalents of a base (e.g. triethylamine (Et₃N), polymer supported diisopropylethylamine or potassium carbonate) present. Similarly, compounds of Formula Ib are prepared by treating amine or amine salts of Formula 1 with an appropriate sulfonyl chloride in an inert solvent with two molar equivalents of a base (e.g. triethylamine, polymer supported diisopropylethylamine or potassium carbonate) present. Suitable solvents are selected from the group consisting of ethers such as tetrahydrofuran, dimethoxyethane, or diethyl ether; hydrocarbons such as toluene or benzene; and halocarbons such as dichloromethane or chloroform.

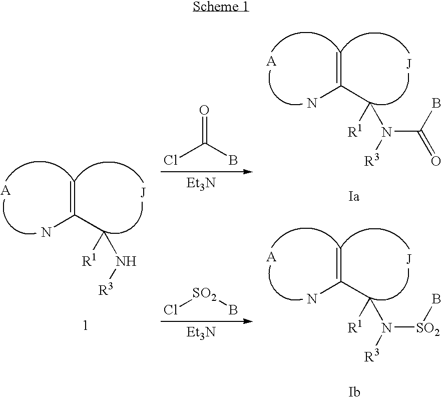

Alternatively, compounds of Formula Ia can be synthesized by reacting the amine or amine salts of Formula 1 with an appropriate carboxylic acid in the presence of an organic dehydrating reagent such as 1,3-dicyclohexylcarbodihide (DCC) or 1-[3-(Dimethylamino)propyl]-3-ethylcarbodiimide hydrochloride (EDC) as depicted in Scheme 2. Suitable solvents are selected from the group consisting of ethers such as tetrahydrofuran, dimethoxyethane, or diethyl ether; hydrocarbons such as toluene or benzene; and halocarbons such as dichloromethane or chloroform.

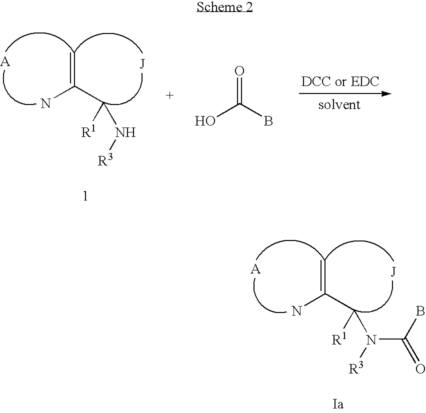

Intermediate amine 1a, a compound of Formula 1 wherein A is a 2-pyridyl ring bearing the indicated substituents, J¹ is —(CH₂)_{q}—, q is 1, 2, 3 or 4 and R¹ and R³ are both hydrogen, can be prepared from the commercially available pyridines of Formula 2 (Scheme 3). As shown in Scheme 3, the CH₂ attached ortho to the pyridine nitrogen atom of Formula 2 can be substituted with NH₂ by a sequence of steps comprising hydrogen peroxide oxidation, acylation, hydrolysis, chlorination, azide displacement and reduction (e.g. catalytic hydrogenation using H₂ and palladium on carbon as catalyst) in procedures analogous to those found in WO00/56729 to provide the amine 1a.

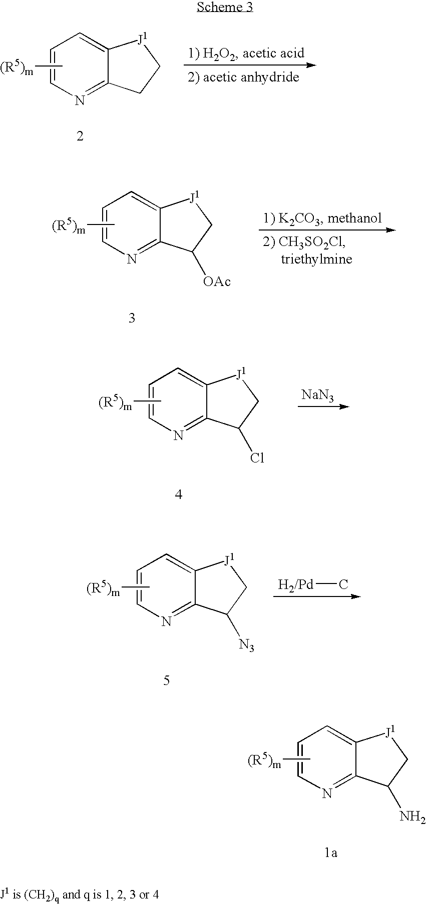

Compounds of Formula Ib wherein J² is —CH₂O—, —CH₂CH₂O—, —CH₂NH—, —CH₂CH₂NH—, —CH₂N(C₁-C₂ alkyl)-, —CH₂CH₂N(C₁-C₂ alkyl)-, —CONH— or —CH₂N(C₁-C₂alkyl)- can be synthesized by intramolecular displacement using compounds of Formula 6 in the presence of a strong base such as sodium hydride in a polar, aprotic solvent such as N,N-dimethylformamide followed by heating in acidic medium as shown in Scheme 4. Similar intermolecular displacements with 2,3-dichloro-substituted pyridines are reported in WO99/42447. The groups enumerated for J² may also be optionally substituted with one or more (up to the total number of hydrogens available for replacement in any specific J-group) substituents independently selected from the group consisting of C₁-C₂ alkyl (e.g. CH(CH₃)O, C(CH₃)₂O, or CH(CH₂CH₃)0), halogen, CN, NO₂ and C₁-C₂ alkoxy.

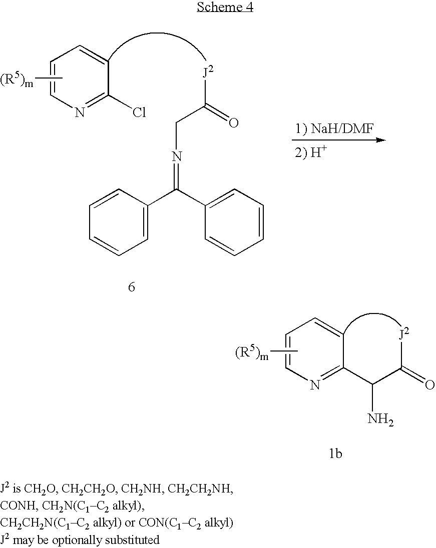

Alternatively, compounds of Formula 1 c (wherein A and J are as previously defined and R¹ is hydrogen) can be prepared by treating compounds of Formula 7 with isoamyl nitrite and a base such as potassium t-butoxide (t-BuOK) followed by reduction of the resulting oximes of Formula 8 (Scheme 5). The reduction can be accomplished, for example, with lithium aluminum hydride, zinc and acetic acid, or catalytic hydrogenation. (See Jerry March, Advanced Organic Chemistry: Reactions, Mechanism and Structure, Third Edition, John Wiley & Sons, New York, 1985, p 1105 for leading references for reduction of oximes).

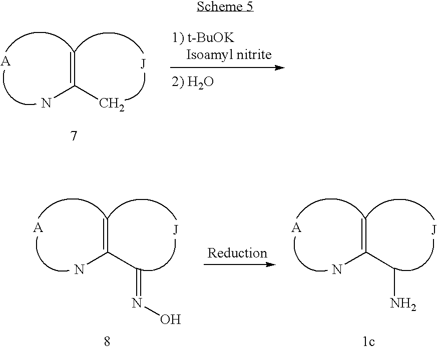

Alternatively, compounds of Formula 1c (wherein A and J are defined and R¹ is hydrogen) can be prepared by reductive amination of compounds of Formula 9 as shown in Scheme 6. Many methods for reductive amination have been reported. For some leading references, see Jerry March, Advanced Organic Chemistry: Reactions, Mechanism and Structure, Third Edition, John Wiley & Sons, New York, 1985, pp. 798-800.

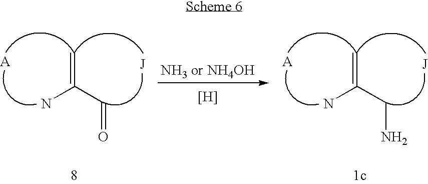

Compounds of Formula 6a wherein J² is optionally substituted —CH₂O— or —CH₂CH₂O—can be prepared by transesterification of N-(diphenylmethylene)glycine esters of Formula 9 with the corresponding alcohols of Formula 10 under basic conditions (Scheme 7). Compounds of Formula 6b wherein J² is optionally substituted —CH₂NH—, —CH₂CH₂NH—, —CH₂N(C₁-C₂alkyl)- or —CH₂CH₂N(C₁-C₂ alkyl)- can be prepared by amidation of N-(diphenylmethylene)glycine esters of Formula 9 with the corresponding amines of Formula 11. Compounds of Formula 6 wherein J² is optionally substituted —CONH— or —CON(C₁-C₂alkyl) can be prepared by amidation of N-(diphenylmethylene)glycine esters of Formula 9 with the corresponding amides of Formula 15.

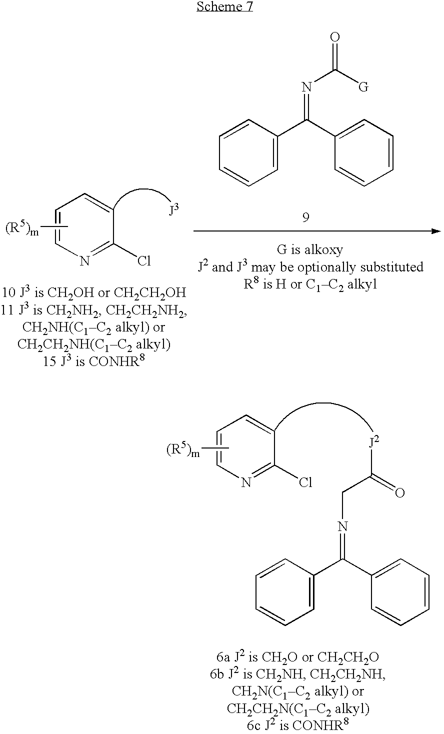

As illustrated in Scheme 8, compounds of Formula 10a wherein J³ is optionally substituted —CH₂OH can be prepared by ortho-lithiation of a compound of Formula 12 followed by reaction with an aldehyde or aldehyde synthon (e.g. paraformaldehyde) or ketone. Similarly, compounds of Formula 10b wherein J³ is optionally substituted —CH₂CH₂OH can be prepared by ortho-lithiation followed by reaction with an epoxide. Ortho-litiations can be accomplished by treatment of the substrate with a strong lithium base such as lithium diisopropylamide (LDA) and are typically carried out at reduced temperatures. Suitable solvents are selected from the group consisting of ethers such as tetrahydrofuran, dimethoxyethane, or diethyl ether and hydrocarbons such as hexane, heptane or ethylbenzene.

As illustrated in Scheme 9, compounds of Formula 10c wherein J³ is —CH₂OH also can be prepared by ortho-lithiation of a compound of Formula 12 and reaction with carbon dioxide to provide a compound of Formula 13, followed by reduction using lithium aluminum hydride (LAH) in a suitable solvent such as toluene. Some isonicotinic acids of Formula 13 may be available commercially.

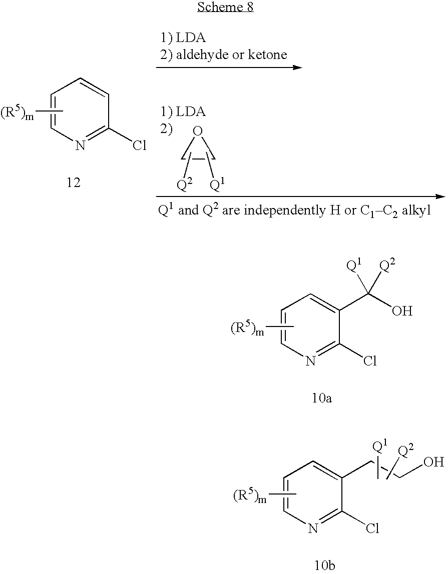

As illustrated in Scheme 9, compounds of Formula 10c wherein J³ is —CH₂OH also can be prepared by ortho-lithiation of a compound of Formula 12 and reaction with carbon dioxide to provide a compound of Formula 13, followed by reduction using lithium aluminum hydride (LAH) in a suitable solvent such as toluene. Some isonicotinic acids of Formula 13 may be available commercially.

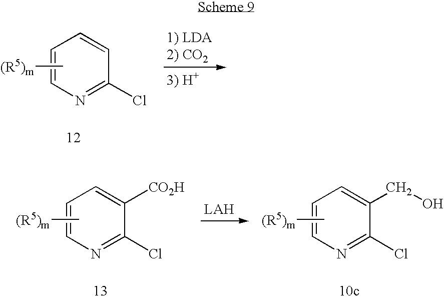

Compounds of Formula 11a can be synthesized from nitrites of Formula 14 by reduction of the nitrile using lithium aluminum hydride (LAH) in a suitable solvent such as toluene to give the corresponding aminomethyl intermediates (Scheme 10). Compounds of Formula 11a can also be synthesized from primary amides of Formula 15 wherein R⁸ is H by reduction using lithium aluminum hydride (LAH) in a suitable solvent such as toluene. Compounds of Formula 11b can be synthesized from secondary amides of Formula 15 wherein R⁸ is C₁-C₂ alkyl by reduction using lithium aluminum hydride (L in a suitable solvent such as toluene. Compounds of Formula 11b can also be synthesized by reductive amination of formaldehyde or acetaldehyde with compounds of Formula 11a. Reductive amination with formaldehyde can be accomplished in the presence of formic acid under Eschweiler-Clarke procedures (see Jerry March, Advanced Organic Chemistry: Reactions, Mechanism and Structure, Third Edition, John Wiley & Sons, New York, 1985, pp. 798-800 and references therein).

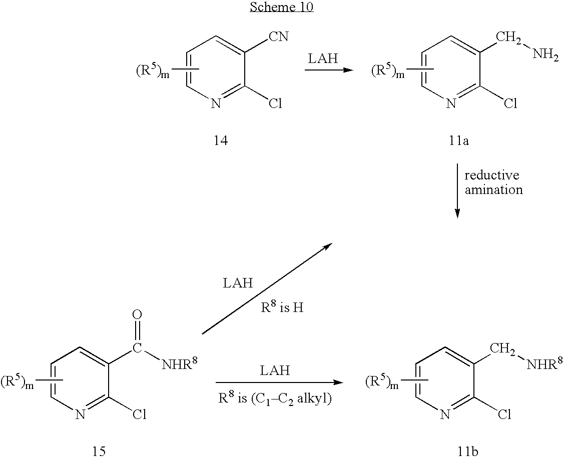

Compounds of Formula 15 may be prepared from compounds of Formula 13 by conversion to the corresponding acid chloride and subsequent reaction with ammonia or a primary amine (Scheme 11). Methods of converting carboxylic acids to the corresponding acid chloride are well-known in the art and include, for example, treatment with thionyl chloride or oxalyl chloride. The acid chloride is treated with the amine or amine salt in an inert solvent with two molar equivalents of a base (e.g. triethylamine, polymer supported diisopropylethylamine or potassium carbonate) present. Suitable solvents are selected from the group consisting of ethers such as tetrahydrofuran, dimethoxyethane, or diethyl ether; hydrocarbons such as toluene or benzene; and halocarbons such as dichloromethane or chloroform. Alternatively, compounds of Formula 15 can be synthesized by reacting the appropriate amine or amine salt with a carboxylic acid of Formula 13 in the presence of an organic dehydrating reagent such as 1,3-dicyclohexylcarbodiimide (DCC) or 1-[3-(Dimethylamino)propyl]-3-ethylcarbodimide hydrochloride CODC). Suitable solvents are selected from the group consisting of ethers such as tetrahydrofuran, dimethoxyeffine, or diethyl ether; hydrocarbons such as toluene or benzene; and halocarbons such as dichloromethane or chloroform.

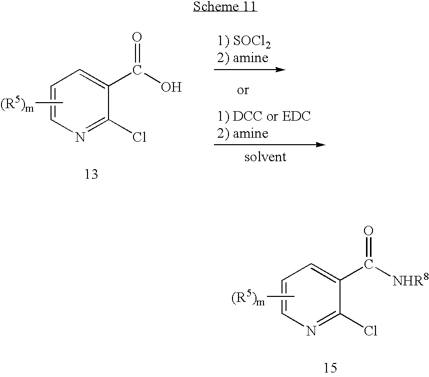

Alternatively, compounds of Formula 11a can be synthesized by reacting compounds of Formula 16, wherein LG is a leaving group such as Br, Cl, methanesulfonyl (—OSO₂Me) or para-toluenesulfonyl (—OSO₂-p-Tol), with ammonia in a protic solvent such as methanol (Scheme 12). Compounds of Formula 11a can also be prepared by reacting compounds of Formula 16 with a potassium salt of phthalimide followed by reaction with either aminoethanol or hydrazine in an alcohol solvent to provide the desired aminomethyl intermediates Formula 11a.

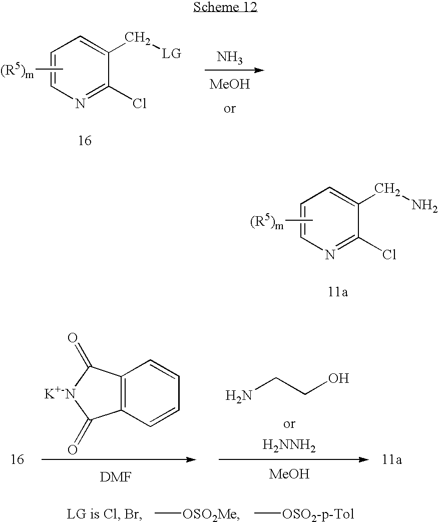

As illustrated in Scheme 13, compounds of Formula 16 wherein LG is —OSO₂Me or —OSO₂-p-Tol (16a) can be prepared by reacting a compound of Formula 10c with the corresponding sulfonyl chloride in the presence of a base such as triethylamine, polymer supported diisopropylethylamine or potassium carbonate. Suitable solvents are selected from the group consisting of ethers such as tetrahydrofuran, dimethoxyethane, or diethyl ether; hydrocarbons such as toluene or benzene; and halocarbons such as dichloromethane or chloroform. Compounds of Formula 16 wherein LG is Br or Cl (16b) can be prepared by treatment of compounds of Formula 17 with halogenating agents such as bromine, chlorine, or N-halosuccinimides under free radical conditions. These transformations are typically carried out with activation by visible or ultraviolet light (hν) and peroxides and are well known in the art.

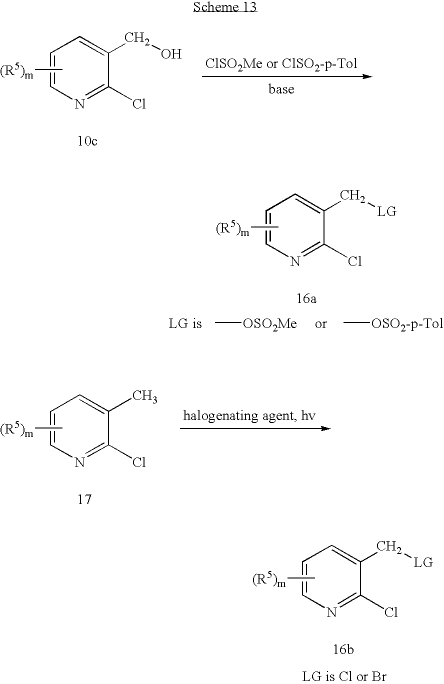

Compounds of Formula 11c can be prepared from compounds of Formula 16 by displacement with cyanide followed by reduction with, for example, lithium aluminum hydride (Scheme 14).

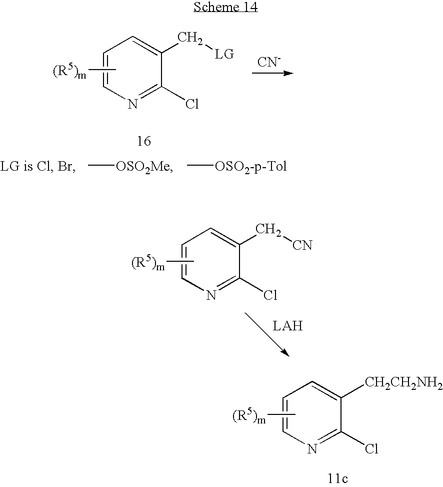

Compounds of Formula 8 can be prepared by intramolecular free-radical acylation of compounds of Formula 18 (Scheme 15). These acylations can be carried out in the presence of t-butyl hydroperoxide, sulfuric acid and ferrous sulfate (see Chem. Communications, 1969, 201 and Gazz. Chim. Ital. 1977, 107, 491 for leading references).

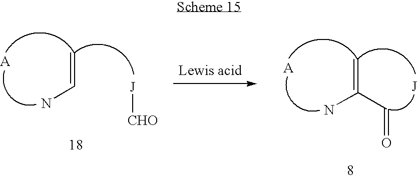

Compounds of Formula 18 wherein J is OCH₂ or NHCH₂ (18a or 18b respectively) can be prepared by alkylation of compounds of Formula 19 with bromoacetaldehyde diethyl acetal followed by acidic hydrolysis of the acetal protecting group (Scheme 16). Compounds of Formula 18 wherein J is OCH₂CH₂ or NHCH₂CH₂ (18c or 18d respectively) can be prepared by Michael addition of acrolein by compounds of Formula 19.

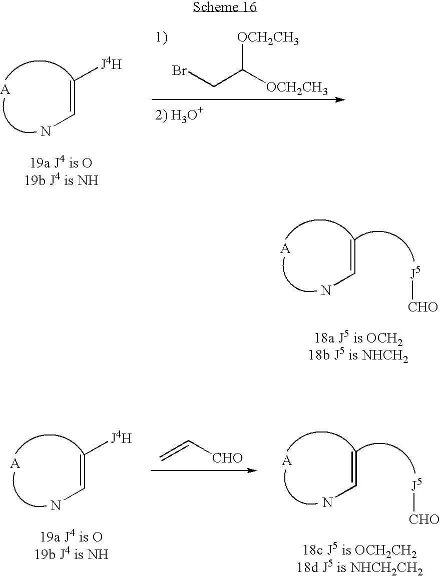

Compounds of Formula 8 wherein J is N(C₁-C₂ alkyl)CH₂ or N(C₁-C₂ alkyl)CH₂CH₂ (8e and 8f respectively) can be prepared by alkylation of compounds of Formula 8b or 8d (Scheme 17) with alkylating agents such alkyl halides such as methyl or ethyl iodide or dialkylsulfonates such as dimethylsulfate, typically in the presence of additional base such as sodium or potassium carbonate.

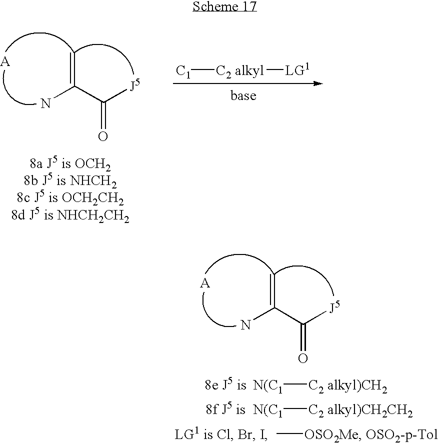

Compounds of Formula 1e wherein J⁶ is CH₂NHCH₂ or CH₂N(C₁-C₂ alkyl)CH₂ can be prepared by reduction of compounds of Formula 1d by lithium aluminum hydride (Scheme 18).

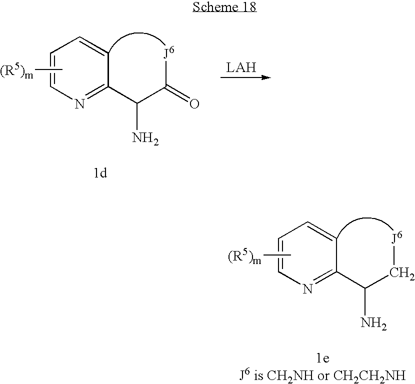

Compounds of Formula 1c (compounds in which W is C=L and L is S) can be synthesized as outlined in Scheme 19. Amides of Formula Ia shown below can be converted to thioamides of Formula 1c by contacting the amide with Lawesson's reagent or phosphorus pentasulfide in an appropriate solvent (for references, see Jerry March, Advanced Organic Chemistry: Reactions, Mechanism and Structure, Fourth Edition, John Wiley & Sons, New York, pp. 893-4).

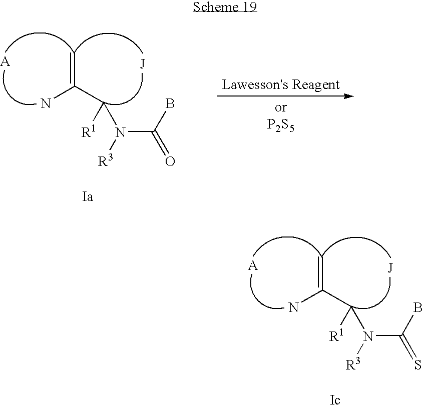

It is recognized that some reagents and reaction conditions described above for preparing compounds of Formula I may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Example is, therefore, to be construed as merely illustrative, and not limiting of the disclosure in any way whatsoever. The starting material for each of the reaction steps of this Example may not have necessarily been prepared by a particular preparative run whose procedure is described in other steps. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s is singlet, d is doublet, t is triplet, q is quartet, m is multiplet, dd is doublet of doublets, dt is doublet of triplets, br s is broad singlet.

### EXAMPLE 1

Preparation of 2.6-dichloro-N-(5,6,7,8-tetrahydro-3-methyl-8-quinolinyl benzamide

Step A: Preparation of 5.6,7,8-tetrahydro-3-methylquinoline

At 0° C., 3-methyl quinoline (20 g, 140 mmol) was dissolved in trifluoroacetic acid (80 mL) and 10 weight % palladium on carbon (10 g) was added. The mixture was treated with hydrogen at room temperature at 345 kPa (50 psi) of H₂ in a Parr shaker apparatus for 5 hours. The resulting mixture was filtered through a Celite® (SiO₂ filter agent) bed to remove the catalyst. The Celite®/charcoal bed was washed with methanol (2×20 mL). The filtrates were then concentrated in vacuo. The residue was partitioned between 2 N aqueous NaOH and diethyl ether. The combined organic extracts were dried (Na₂SO₄) and concentrated to give the title compound (19 g). ¹H NMR (CDCl₃) δ: 8.17 (s, 1H), 7.15 (s,1H), 2.87 (t, J=6.2 Hz,2H), 2.72 (t, J=6.4 Hz,2H), 2.25 (s,3H), 1.86 (m,2H), 1.80 (m,2H).

Step B: Preparation of 5,6.7.8-tetrahydro-3-methyl-8-quinolinyl acetate

A solution of 5,6,7,8-tetrahydro-3-methylquinoline (39.1 g, 266 mmol) in acetic acid (130 mL) was treated with 30% aqueous H₂O₂ (26 mL) at room temperature, and the resulting reaction mixture was heated to 70° C. for 6 hours. An additional portion of 30% H₂O₂ (26 mL) was added, and the mixture was heated to 70° C. overnight The reaction mixture was cooled to room temperature and concentrated in vacuo. The residue was dissolved in dichloromethane and treated with Na₂CO₃ (87 g). After 1 hour, the mixture was filtered and washed with dichloromethane. The filtrate was concentrated in vacuo to give a semi-solid oil.

A solution of the semi-solid oil in acetic anhydride (200 mL) was heated to 90° C. overnight. The reaction mixture was cooled to room temperature and the acetic anhydride was removed in vacuo. Distillation of the residue under reduced pressure provided the title compound (49 g). ¹H NMR (CDCl₃) δ: 8.34 (s, 1H), 7.28 (s,1H), 5.93 (t, J=4.4 Hz,1H), 2.8 (m,2H), 2.31 (s,3H), 2.10 (s,3H), 2.18-1.77 (m,4H).

Step C: Preparation of 8-chloro-5.6.7.8-tetrahydro-3-methylquinoline

A suspension of 5,6,7,8-tetrahydro-3-methyl-8-quinolinyl acetate (49 g, 195 mmol) and K₂CO₃ (100 g) in methanol (250 mL) was stirred at room temperature overnight. The mixture was partitioned between water and dichloromethane. The combined organic extract was dried (Na₂SO₄) and concentrated. The residue was purified by flash chromatography on silica gel (using a gradient of 10% to 60% ethyl acetate in hexanes as eluent) to give a light brownish oil (24 g).

Methanesulfonyl chloride (25.6 g) was added slowly to a solution of the oil (24 g) and triethylamine in dichloromethane (150 mL) at 0° C. The reaction mixture was slowly warmed up to room temperature and then heated to reflux overnight. The mixture was cooled to room temperature and partitioned between water and dichloromethane. The combined organic extract was dried (Na₂SO₄) and concentrated. The residue was purified by flash chromatography on silica gel (using a gradient of 10% to 60% ethyl acetate in hexanes as eluent) to give the title compound as a light yellowish oil (21.8 g). ¹HNMR (CDCl₃) o: 8.31 (s,1H), 7.24 (s,1H), 5.29 (t, J=3.0 Hz,1H), 2.81 (m,1H), 2.37 (m,1H), 2.30 (s,3H), 2.19 (m,2H), 1.88 (m,1H).

Step D: Preparation of 5.6,7,8-tetrahydro-3-methyl-8-quinolinamine

A suspension of 8-chloro-5,6,7,8-tetrahydro-3-methylquinoline (21.8 g) and sodium azide (15.6 g) was heated to 70° C. for 4 hours. The reaction mixture was cooled to room temperature and partitioned between water and diethyl ether. The combined organic extract was dried (Na₂SO₄) and concentrated. The residue (17.2 g) was dissolved in methanol (170 mL) and 10 weight % palladium on carbon (1.73 g) was added. The mixture was treated with hydrogen at room temperature at 276 kPa (40 psi) H₂ in a Parr shaker apparatus for 4 hours. The resulting mixture was filtered through a Celite® bed. The Celite®/charcoal bed was washed with methanol (2×10 mL). The filtrates were then concentrated in vacuo to give (13 g) of the title compound. ¹HNMR (CDCl₃) δ: 8.32 (s,1H), 7.27 (s,1H), 4.69 (t, J=4.1 Hz,1H), 2.75 (m,2H), 2.31 (s,3H), 2.01-1.78 (m,4H).

Step E: Preparation of 2,6-dichloro-N-(5,6,7,8-tetrahydro-3-methyl-8-quinolinyl)benzamide

A suspension of 5,6,7,8-tetrahydro-3-methyl-8-quinolinamine (162 mg, 1 mmol), 2,6-dichlorobenzoyl chloride (209.5 mg, 1 mmol) and polymer-supported diisopropylethylamine (1.0 g, 3 mmol/g) in acetonitrile (5 mL) was shaken at room temperature overnight. The reaction mixture was filtered and the solid washed with acetonitrile (2×2 mL). The filtrate was concentrated and the resulting residue was purified by flash chromatography on silica gel (using a gradient of 10% to 60% ethyl acetate in hexanes as eluent) to give the title compound, a compound of the invention (190 mg).

¹H NMR (CDCl₃) δ: 8.22 (s,1H), 7.30 (s,1H), 7.36-7.23 (m,3H), 6.99 (bs,1H), 5.03 (m,1H), 2.82 (m,3H), 2.29 (s,3H), 1.94 (m,3H).

By the procedures described herein together with methods known in the art, the following compounds of Tables 1-8 can be prepared. The following abbreviations are used in the Tables that follow: “Me” means methyl, “OMe” means methoxy, “SMe” means methylthio, “CN” means cyano, “NO₂” means nitro, “S(O)Me” means methylsulfinyl, and “S(O)₂Me” means methylsulfonyl. The substituents M and R are equivalent to independent R⁵ substituents that have been located in the positions indicated. The substituents T, U and V are equivalent to independent R⁶ substituents that have been located in the positions indicated.

TABLE 1

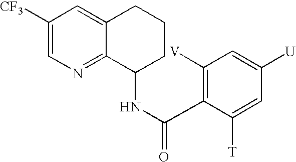

| T | U | V | T | U | V | T | U | V | T | U | V |
|---|---|---|---|---|---|---|---|---|---|---|---|
| Me | Me | Me | F | Me | Me | F | F | Me | CF₃ | Me | Me |
| Me | Me | F | F | Me | F | F | F | F | CF₃ | Me | F |
| Me | Me | Cl | F | Me | Cl | F | F | Cl | CF₃ | Me | Cl |
| Me | Me | Br | F | Me | Br | F | F | Br | CF₃ | Me | Br |
| Me | Me | CF₃ | F | Me | CF₃ | F | F | CF₃ | CF₃ | Me | CF₃ |
| Me | Me | NO₂ | F | Me | NO₂ | F | F | NO₂ | CF₃ | Me | NO₂ |
| Me | Me | OMe | F | Me | OMe | F | F | OMe | CF₃ | Me | OMe |
| Me | F | Me | Cl | Me | Me | Cl | F | Me | NO₂ | Me | Me |
| Me | F | F | Cl | Me | F | Cl | F | F | NO₂ | Me | F |
| Me | F | Cl | Cl | Me | Cl | Cl | F | Cl | NO₂ | Me | Cl |
| Me | F | Br | Cl | Me | Br | Cl | F | Br | NO₂ | Me | Br |
| Me | F | CF₃ | Cl | Me | CF₃ | Cl | F | CF₃ | NO₂ | Me | CF₃ |
| Me | F | NO₂ | Cl | Me | NO₂ | Cl | F | NO₂ | NO₂ | Me | NO₂ |
| Me | F | OMe | Cl | Me | OMe | Cl | F | OMe | NO₂ | Me | OMe |
| Me | Cl | Me | F | Cl | Me | F | Br | Me | CF₃ | F | Me |
| Me | Cl | F | F | Cl | F | F | Br | F | CF₃ | F | F |
| Me | Cl | Cl | F | Cl | Cl | F | Br | Cl | CF₃ | F | Cl |
| Me | Cl | Br | F | Cl | Br | F | Br | Br | CF₃ | F | Br |
| Me | Cl | CF₃ | F | Cl | CF₃ | F | Br | CF₃ | CF₃ | F | CF₃ |
| Me | Cl | NO₂ | F | Cl | NO₂ | F | Br | NO₂ | CF₃ | F | NO₂ |
| Me | Cl | OMe | F | Cl | OMe | F | Br | OMe | CF₃ | F | OMe |
| Me | Br | Me | Cl | Cl | Me | Cl | Br | Me | NO₂ | F | Me |
| Me | Br | F | Cl | Cl | F | Cl | Br | F | NO₂ | F | F |
| Me | Br | Cl | Cl | Cl | Cl | Cl | Br | Cl | NO₂ | F | Cl |
| Me | Br | Br | Cl | Cl | Br | Cl | Br | Br | NO₂ | F | Br |
| Me | Br | CF₃ | Cl | Cl | CF₃ | Cl | Br | CF₃ | NO₂ | F | CF₃ |
| Me | Br | NO₂ | Cl | Cl | NO₂ | Cl | Br | NO₂ | NO₂ | F | NO₂ |
| Me | Br | OMe | Cl | Cl | OMe | Cl | Br | OMe | NO₂ | F | OMe |
| Me | CF₃ | Me | F | CF₃ | Me | F | NO₂ | Me | CF₃ | Cl | Me |
| Me | CF₃ | F | F | CF₃ | F | F | NO₂ | F | CF₃ | Cl | F |
| Me | CF₃ | Cl | F | CF₃ | Cl | F | NO₂ | Cl | CF₃ | Cl | Cl |
| Me | CF₃ | Br | F | CF₃ | Br | F | NO₂ | Br | CF₃ | Cl | Br |
| Me | CF₃ | CF₃ | F | CF₃ | CF₃ | F | NO₂ | CF₃ | CF₃ | Cl | CF₃ |
| Me | CF₃ | NO₂ | F | CF₃ | NO₂ | F | NO₂ | NO₂ | CF₃ | Cl | NO₂ |
| Me | CF₃ | OMe | F | CF₃ | OMe | F | NO₂ | OMe | CF₃ | Cl | OMe |
| Me | NO₂ | Me | Cl | CF₃ | Me | Cl | NO₂ | Me | NO₂ | Cl | Me |
| Me | NO₂ | F | Cl | CF₃ | F | Cl | NO₂ | F | NO₂ | Cl | F |
| Me | NO₂ | Cl | Cl | CF₃ | Cl | Cl | NO₂ | Cl | NO₂ | Cl | Cl |
| Me | NO₂ | Br | Cl | CF₃ | Br | Cl | NO₂ | Br | NO₂ | Cl | Br |
| Me | NO₂ | CF₃ | Cl | CF₃ | CF₃ | Cl | NO₂ | CF₃ | NO₂ | Cl | CF₃ |
| Me | NO₂ | NO₂ | Cl | CF₃ | NO₂ | Cl | NO₂ | NO₂ | NO₂ | Cl | NO₂ |
| Me | NO₂ | OMe | Cl | CF₃ | OMe | Cl | NO₂ | OMe | NO₂ | Cl | OMe |
| Me | OMe | Me | F | OMe | Me | F | H | Me | CF₃ | Br | Me |
| Me | OMe | F | F | OMe | F | F | H | F | CF₃ | Br | F |
| Me | OMe | Cl | F | OMe | Cl | F | H | Cl | CF₃ | Br | Cl |
| Me | OMe | Br | F | OMe | Br | F | H | Br | CF₃ | Br | Br |
| Me | OMe | CF₃ | F | OMe | CF₃ | F | H | GF3 | CF₃ | Br | CF₃ |
| Me | OMe | NO₂ | F | OMe | NO₂ | F | H | NO₂ | CF₃ | Br | NO₂ |
| Me | OMe | OMe | F | OMe | OMe | F | H | OMe | CF₃ | Br | OMe |
| Me | H | Me | Cl | OMe | Me | Cl | H | Me | NO₂ | Br | Me |
| Me | H | F | Cl | OMe | F | Cl | H | F | NO₂ | Br | F |
| Me | H | Cl | Cl | OMe | Cl | Cl | H | Cl | NO~ | Br | Cl |
| Me | H | Br | Cl | OMe | Br | Cl | H | Br | NO₂ | Br | Br |
| Me | H | CF₃ | Cl | OMe | CF₃ | Cl | H | CF₃ | NO₂ | Br | CF₃ |
| Me | H | NO₂ | Cl | OMe | NO₂ | Cl | H | NO₂ | NO₂ | Br | NO₂ |
| Me | H | OMe | Cl | OMe | OMe | Cl | H | OMe | NO₂ | Br | OMe |
| OMe | Me | Me | Br | Me | Me | Br | F | Me | CF₃ | CF₃ | Me |
| OMe | Me | F | Br | Me | F | Br | F | F | CF₃ | CF₃ | F |
| OMe | Me | Cl | Br | Me | Cl | Br | F | Cl | CF₃ | CF₃ | Cl |
| OMe | Me | Br | Br | Me | Br | Br | F | Br | CF₃ | CF₃ | Br |
| OMe | Me | CF₃ | Br | Me | CF₃ | Br | F | CF₃ | CF₃ | CF₃ | CF₃ |
| OMe | OMe | NO₂ | Br | Me | NO₂ | Br | F | NO₂ | CF₃ | CF₃ | NO₂ |
| OMe | Me | OMe | Br | Me | OMe | Br | F | OMe | CF₃ | CF₃ | OMe |
| OMe | F | Me | Br | Cl | Me | Br | Br | Me | NO₂ | CF₃ | Me |
| OMe | F | F | Br | Cl | F | Br | Br | F | NO₂ | CF₃ | F |
| OMe | F | Cl | Br | Cl | Cl | Br | Br | Cl | NO₂ | CF₃ | Cl |
| OMe | F | Br | Br | Cl | Br | Br | Br | Br | NO₂ | CF₃ | Br |
| OMe | F | CF₃ | Br | Cl | CF₃ | Br | Br | CF₃ | NO₂ | CF₃ | CF₃ |
| OMe | F | NO₂ | Br | Cl | NO₂ | Br | Br | NO₂ | NO₂ | CF₃ | NO₂ |
| OMe | F | OMe | Br | Cl | OMe | Br | Br | OMe | NO₂ | CF₃ | OMe |
| OMe | Cl | Me | Br | CF₃ | Me | Br | NO₂ | Me | CF₃ | NO₂ | Me |
| OMe | Cl | F | Br | CF₃ | F | Br | NO₂ | F | CF₃ | NO₂ | F |
| OMe | Cl | Cl | Br | CF₃ | Cl | Br | NO₂ | Cl | CF₃ | NO₂ | Cl |
| OMe | Cl | Br | Br | CF₃ | Br | Br | NO₂ | Br | CF₃ | NO₂ | Br |
| OMe | Cl | CF₃ | Br | CF₃ | CF₃ | Br | NO₂ | CF₃ | CF₃ | NO₂ | CF₃ |
| OMe | Cl | NO₂ | Br | CF₃ | NO₂ | Br | NO₂ | NO₂ | CF₃ | NO₂ | NO₂ |
| OMe | Cl | OMe | Br | CF₃ | OMe | Br | NO₂ | OMe | CF₃ | NO₂ | OMe |
| OMe | H | Me | Br | OMe | Me | Br | H | Me | NO₂ | NO₂ | Me |
| OMe | H | F | Br | OMe | F | Br | H | F | NO₂ | NO₂ | F |
| OMe | H | Cl | Br | OMe | Cl | Br | H | Cl | NO₂ | NO₂ | Cl |
| OMe | H | OMe | Br | OMe | Br | Br | H | Br | NO₂ | NO₂ | Br |
| OMe | OMe | CF₃ | Br | OMe | CF₃ | Br | H | CF₃ | NO₂ | NO₂ | CF₃ |
| OMe | OMe | NO₂ | Br | OMe | NO₂ | Br | H | NO₂ | NO₂ | NO₂ | NO₂ |
| OMe | OMe | OMe | Br | OMe | OMe | Br | H | OMe | NO₂ | NO₂ | OMe |
| OMe | Br | Me | OMe | CF₃ | Me | CF₃ | H | Me | CF₃ | OMe | Me |
| OMe | Br | F | OMe | CF₃ | F | CF₃ | H | F | CF₃ | OMe | F |
| OMe | Br | Cl | OMe | CF₃ | Cl | CF₃ | H | Cl | CF₃ | OMe | Cl |
| OMe | Br | Br | OMe | CF₃ | Br | CF₃ | H | Br | CF₃ | OMe | Br |
| OMe | Br | CF₃ | OMe | CF₃ | CF₃ | CF₃ | H | CF₃ | CF₃ | OMe | CF₃ |
| OMe | Br | NO₂ | OMe | CF₃ | NO₂ | CF₃ | H | NO₂ | CF₃ | OMe | NO₂ |
| OMe | Br | OMe | OMe | CF₃ | OMe | CF₃ | H | OMe | CF₃ | OMe | OMe |
| OMe | H | Br | OMe | NO₂ | Me | NO₂ | H | Me | NO₂ | OMe | Me |
| OMe | H | CF₃ | OMe | NO₂ | F | NO₂ | H | F | NO₂ | OMe | F |
| OMe | H | NO₂ | OMe | NO₂ | Cl | NO₂ | H | Cl | NO₂ | OMe | Cl |
| OMe | OMe | Me | OMe | NO₂ | Br | NO₂ | H | Br | NO₂ | OMe | Br |
| OMe | OMe | F | OMe | NO₂ | CF₃ | NO₂ | H | CF₃ | NO₂ | OMe | CF₃ |
| OMe | OMe | Cl | OMe | NO₂ | NO₂ | NO₂ | H | NO₂ | NO₂ | OMe | NO₂ |
| OMe | OMe | Br | OMe | NO₂ | OMe | NO₂ | H | OMe | NO₂ | OMe | OMe |

TABLE 2

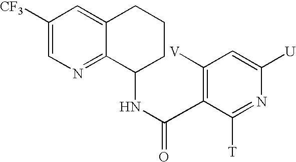

| T | U | V | T | U | V | T | U | V | T | U | V |
|---|---|---|---|---|---|---|---|---|---|---|---|
| Me | Me | Me | F | Me | Me | F | F | Me | CF₃ | Me | Me |
| Me | Me | F | F | Me | F | F | F | F | CF₃ | Me | F |
| Me | Me | Cl | F | Me | Cl | F | F | Cl | CF₃ | Me | Cl |
| Me | Me | Br | F | Me | Br | F | F | Br | CF₃ | Me | Br |
| Me | Me | CF₃ | F | Me | CF₃ | F | F | CF₃ | CF₃ | Me | CF₃ |
| Me | Me | NO₂ | F | Me | NO₂ | F | F | NO₂ | CF₃ | Me | NO₂ |
| Me | Me | OMe | F | Me | OMe | F | F | OMe | CF₃ | Me | OMe |
| Me | F | Me | Cl | Me | Me | Cl | F | Me | NO₂ | Me | Me |
| Me | F | F | Cl | Me | F | Cl | F | F | NO₂ | Me | F |
| Me | F | Cl | Cl | Me | Cl | Cl | F | Cl | NO₂ | Me | Cl |
| Me | F | Br | Cl | Me | Br | Cl | F | Br | NO₂ | Me | Br |
| Me | F | CF₃ | Cl | Me | CF₃ | Cl | F | CF₃ | NO₂ | Me | CF₃ |
| Me | F | NO₂ | Cl | Me | NO₂ | Cl | F | NO₂ | NO₂ | Me | NO₂ |
| Me | F | OMe | Cl | Me | OMe | Cl | F | OMe | NO₂ | Me | OMe |
| Me | Cl | Me | F | Cl | Me | F | Br | Me | CF₃ | F | Me |
| Me | Cl | F | F | Cl | F | F | Br | F | CF₃ | F | F |
| Me | Cl | Cl | F | Cl | Cl | F | Br | Cl | CF₃ | F | Cl |
| Me | Cl | Br | F | Cl | Br | F | Br | Br | CF_{3I} | F | Br |
| Me | Cl | CF₃ | F | Cl | CF₃ | F | Br | CF₃ | CF₃ | F | CF₃ |
| Me | Cl | NO₂ | F | Cl | NO₂ | F | Br | NO₂ | CF₃ | F | NO₂ |
| Me | Cl | OMe | F | Cl | OMe | F | Br | OMe | CF₃ | F | OMe |
| Me | Br | Me | Cl | Cl | Me | Cl | Br | Me | NO₂ | F | Me |
| Me | Br | F | Cl | Cl | F | Cl | Br | F | NO₂ | F | F |
| Me | Br | Cl | Cl | Cl | Cl | Cl | Br | Cl | NO₂ | F | Cl |
| Me | Br | Br | Cl | Cl | Br | Cl | Br | Br | NO₂ | F | Br |
| Me | Br | CF₃ | Cl | Cl | CF₃ | Cl | Br | CF₃ | NO₂ | F | CF₃ |
| Me | Br | NO₂ | Cl | Cl | NO₂ | Cl | Br | NO₂ | NO₂ | F | NO₂ |
| Me | Br | OMe | Cl | Cl | OMe | Cl | Br | OMe | NO₂ | F | OMe |
| Me | CF₃ | Me | F | CF₃ | Me | F | NO₂ | Me | CF₃ | Cl | Me |
| Me | CF₃ | F | F | CF₃ | F | F | NO₂ | F | CF₃ | Cl | F |
| Me | CF₃ | Cl | F | CF₃ | Cl | F | NO₂ | Cl | CF₃ | Cl | Cl |
| Me | CF₃ | Br | F | CF₃ | Br | F | NO₂ | Br | CF₃ | Cl | Br |
| Me | CF₃ | CF₃ | F | CF₃ | CF₃ | F | NO₂ | CF₃ | CF₃ | Cl | CF₃ |
| Me | CF₃ | NO₂ | F | CF₃ | NO₂ | F | NO₂ | NO₂ | CF₃ | Cl | NO₂ |
| Me | CF₃ | OMe | F | CF₃ | OMe | F | NO₂ | OMe | CF₃ | Cl | OMe |
| Me | NO₂ | Me | Cl | CF₃ | Me | Cl | NO₂ | Me | NO₂ | Cl | Me |
| Me | NO₂ | F | Cl | CF₃ | F | Cl | NO₂ | F | NO₂ | Cl | F |
| Me | NO₂ | Cl | Cl | CF₃ | Cl | Cl | NO₂ | Cl | NO₂ | Cl | Cl |
| Me | NO₂ | Br | Cl | CF₃ | Br | Cl | NO₂ | Br | NO₂ | Cl | Br |
| Me | NO₂ | CF₃ | Cl | CF₃ | CF₃ | Cl | NO₂ | CF₃ | NO₂ | Cl | CF₃ |
| Me | NO₂ | NO₂ | Cl | CF₃ | NO₂ | Cl | NO₂ | NO₂ | NO₂ | Cl | NO₂ |
| Me | NO₂ | OMe | Cl | CF₃ | OMe | Cl | NO₂ | OMe | NO₂ | Cl | OMe |
| Me | OMe | Me | F | OMe | Me | F | H | Me | CF₃ | Br | Me |
| Me | OMe | F | F | OMe | F | F | H | F | CF₃ | Br | F |
| Me | OMe | Cl | F | OMe | Cl | F | H | Cl | CF₃ | Br | Cl |
| Me | OMe | Br | F | OMe | Br | F | H | Br | CF₃ | Br | Br |
| Me | OMe | CF₃ | F | OMe | CF₃ | F | H | CF₃ | CF₃ | Br | CF₃ |
| Me | OMe | NO₂ | F | OMe | NO₂ | F | H | NO₂ | CF₃ | Br | NO₂ |
| Me | OMe | OMe | F | OMe | OMe | F | H | OMe | CF₃ | Br | OMe |
| Me | H | Me | Cl | OMe | Me | Cl | H | Me | NO₂ | Br | Me |
| Me | H | F | Cl | OMe | F | Cl | H | F | NO₂ | Br | F |
| Me | H | Cl | Cl | OMe | Cl | Cl | H | Cl | NO₂ | Br | Cl |
| Me | H | Br | Cl | OMe | Br | Cl | H | Br | NO₂ | Br | Br |
| Me | H | CF₃ | Cl | OMe | CF₃ | Cl | H | CF₃ | NO₂ | Br | CF₃ |
| Me | H | NO₂ | Cl | OMe | NO₂ | Cl | H | NO₂ | NO₂ | Br | NO₂ |
| Me | H | OMe | Cl | OMe | OMe | Cl | H | OMe | NO₂ | Br | OMe |
| OMe | Me | Me | Br | Me | Me | Br | F | Me | CF₃ | CF₃ | Me |
| OMe | Me | F | Br | Me | F | Br | F | F | CF₃ | CF₃ | F |
| OMe | Me | Cl | Br | Me | Cl | Br | F | Cl | CF₃ | CF₃ | Cl |
| OMe | Me | Br | Br | Me | Br | Br | F | Br | CF₃ | CF₃ | Br |
| OMe | Me | CF₃ | Br | Me | CF₃ | Br | F | CF₃ | CF₃ | CF₃ | CF₃ |
| OMe | Me | NO₂ | Br | Me | NO₂ | Br | F | NO₂ | CF₃ | CF₃ | NO₂ |
| OMe | Me | OMe | Br | Me | OMe | Br | F | OMe | CF₃ | CF₃ | OMe |
| OMe | F | Me | Br | Cl | Me | Br | Br | Me | NO₂ | CF₃ | Me |
| OMe | F | F | Br | Cl | F | Br | Br | F | NO₂ | CF₃ | F |
| OMe | F | Cl | Br | Cl | Cl | Br | Br | Cl | NO₂ | CF₃ | Cl |
| OMe | F | Br | Br | Cl | Br | Br | Br | Br | NO₂ | CF₃ | Br |
| OMe | F | CF₃ | Br | Cl | CF₃ | Br | Br | CF₃ | NO₂ | CF₃ | CF₃ |
| OMe | F | NO₂ | Br | Cl | NO₂ | Br | Br | NO₂ | NO₂ | CF₃ | NO₂ |
| OMe | F | OMe | Br | Cl | OMe | Br | Br | OMe | NO₂ | CF₃ | OMe |
| OMe | Cl | Me | Br | CF₃ | Me | Br | NO₂ | Me | CF₃ | NO₂ | Me |
| OMe | Cl | F | Br | CF₃ | F | Br | NO₂ | F | CF₃ | NO₂ | F |
| OMe | Cl | Cl | Br | CF₃ | Cl | Br | NO₂ | Cl | CF₃ | NO₂ | Cl |
| OMe | Cl | Br | Br | CF₃ | Br | Br | NO₂ | Br | CF₃ | NO₂ | Br |
| OMe | Cl | CF₃ | Br | CF₃ | CF₃ | Br | NO₂ | CF₃ | CF₃ | NO₂ | CF₃ |
| OMe | Cl | NO₂ | Br | CF₃ | NO₂ | Br | NO₂ | NO₂ | CF₃ | NO₂ | NO₂ |
| OMe | Cl | OMe | Br | CF₃ | OMe | Br | NO₂ | OMe | CF₃ | NO₂ | OMe |
| OMe | H | Me | Br | OMe | Me | Br | H | Me | NO₂ | NO₂ | Me |
| OMe | H | F | Br | OMe | F | Br | H | F | NO₂ | NO₂ | F |
| OMe | H | Cl | Br | OMe | Cl | Br | H | Cl | NO₂ | NO₂ | Cl |
| OMe | H | OMe | Br | OMe | Br | Br | H | Br | NO₂ | NO₂ | Br |
| OMe | OMe | CF₃ | Br | OMe | CF₃ | Br | H | CF₃ | NO₂ | NO₂ | CF₃ |
| OMe | OMe | NO₂ | Br | OMe | NO₂ | Br | H | NO₂ | NO₂ | NO₂ | NO₂ |
| OMe | OMe | OMe | Br | OMe | OMe | Br | H | OMe | NO₂ | NO₂ | OMe |
| OMe | Br | Me | OMe | CF₃ | Me | CF₃ | H | Me | CF₃ | OMe | Me |
| OMe | Br | F | OMe | CF₃ | F | CF₃ | H | F | CF₃ | OMe | F |
| OMe | Br | Cl | OMe | CF₃ | Cl | CF₃ | H | Cl | CF₃ | OMe | Cl |
| OMe | Br | Br | OMe | CF₃ | Br | CF₃ | H | Br | CF₃ | OMe | Br |
| OMe | Br | CF₃ | OMe | CF₃ | CF₃ | CF₃ | H | CF₃ | CF₃ | OMe | CF₃ |
| OMe | Br | NO₂ | OMe | CF₃ | NO₂ | CF₃ | H | NO₂ | CF₃ | OMe | NO₂ |
| OMe | Br | OMe | OMe | CF₃ | OMe | CF₃ | H | OMe | CF₃ | OMe | OMe |
| OMe | H | Br | OMe | NO₂ | Me | NO₂ | H | Me | NO₂ | OMe | Me |
| OMe | H | CF₃ | OMe | NO₂ | F | NO₂ | H | F | NO₂ | OMe | F |
| OMe | H | NO₂ | OMe | NO₂ | Cl | NO₂ | H | Cl | NO₂ | OMe | Cl |
| OMe | OMe | Me | OMe | NO₂ | Br | NO₂ | H | Br | NO₂ | OMe | Br |
| OMe | OMe | F | OMe | NO₂ | CF₃ | NO₂ | H | CF₃ | NO₂ | OMe | CF₃ |
| OMe | OMe | Cl | OMe | NO₂ | NO₂ | NO₂ | H | NO₂ | NO₂ | OMe | NO₂ |
| OMe | OMe | Br | OMe | NO₂ | OMe | NO₂ | H | OMe | NO₂ | OMe | OMe |

TABLE 3

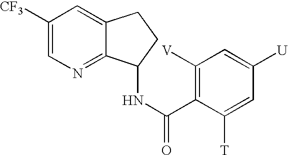

| T | U | V | T | U | V | T | U | V | T | U | V |
|---|---|---|---|---|---|---|---|---|---|---|---|
| Me | Me | Me | F | Me | Me | F | F | Me | CF₃ | Me | Me |
| Me | Me | F | F | Me | F | F | F | F | CF₃ | Me | F |
| Me | Me | Cl | F | Me | Cl | F | F | Cl | CF₃ | Me | Cl |
| Me | Me | Br | F | Me | Br | F | F | Br | CF₃ | Me | Br |
| Me | Me | CF₃ | F | Me | CF₃ | F | F | CF₃ | CF₃ | Me | CF₃ |
| Me | Me | NO₂ | F | Me | NO₂ | F | F | NO₂ | CF₃ | Me | NO₂ |
| Me | Me | OMe | F | Me | OMe | F | F | OMe | CF₃ | Me | OMe |
| Me | F | Me | Cl | Me | Me | Cl | F | Me | NO₂ | Me | Me |
| Me | F | F | Cl | Me | F | Cl | F | F | NO₂ | Me | F |
| Me | F | Cl | Cl | Me | Cl | Cl | F | Cl | NO₂ | Me | Cl |
| Me | F | Br | Cl | Me | Br | Cl | F | Br | NO₂ | Me | Br |
| Me | F | CF₃ | Cl | Me | CF₃ | Cl | F | CF₃ | NO₂ | Me | CF₃ |
| Me | F | NO₂ | Cl | Me | NO₂ | Cl | F | NO₂ | NO₂ | Me | NO₂ |
| Me | F | OMe | Cl | Me | OMe | Cl | F | OMe | NO₂ | Me | OMe |
| Me | Cl | Me | F | Cl | Me | F | Br | Me | CF₃ | F | Me |
| Me | Cl | F | F | Cl | F | F | Br | F | CF₃ | F | F |
| Me | Cl | Cl | F | Cl | Cl | F | Br | Cl | CF₃ | F | Cl |
| Me | Cl | Br | F | Cl | Br | F | Br | Br | CF₃ | F | Br |
| Me | Cl | CF₃ | F | Cl | CF₃ | F | Br | CF₃ | CF₃ | F | CF₃ |
| Me | Cl | NO₂ | F | Cl | NO₂ | F | Br | NO₂ | CF₃ | F | NO₂ |
| Me | Cl | OMe | F | Cl | OMe | F | Br | OMe | CF₃ | F | OMe |
| Me | Br | Me | Cl | Cl | Me | Cl | Br | Me | NO₂ | F | Me |
| Me | Br | F | Cl | Cl | F | Cl | Br | F | NO₂ | F | F |
| Me | Br | Cl | Cl | Cl | Cl | Cl | Br | Cl | NO₂ | F | Cl |
| Me | Br | Br | Cl | Cl | Br | Cl | Br | Br | NO₂ | F | Br |
| Me | Br | CF₃ | Cl | Cl | CF₃ | Cl | Br | CF₃ | NO₂ | F | CF₃ |
| Me | Br | NO₂ | Cl | Cl | NO₂ | Cl | Br | NO₂ | NO₂ | F | NO₂ |
| Me | Br | OMe | Cl | Cl | OMe | Cl | Br | OMe | NO₂ | F | OMe |
| Me | CF₃ | Me | F | CF₃ | Me | F | NO₂ | Me | CF₃ | Cl | Me |
| Me | CF₃ | F | F | CF₃ | F | F | NO₂ | F | CF₃ | Cl | F |
| Me | CF₃ | Cl | F | CF₃ | Cl | F | NO₂ | Cl | CF₃ | Cl | Cl |
| Me | CF₃ | Br | F | CF₃ | Br | F | NO₂ | Br | CF₃ | Cl | Br |
| Me | CF₃ | CF₃ | F | CF₃ | CF₃ | F | NO₂ | CF₃ | CF₃ | Cl | CF₃ |
| Me | CF₃ | NO₂ | F | CF₃ | NO₂ | F | NO₂ | NO₂ | CF₃ | Cl | NO₂ |
| Me | CF₃ | OMe | F | CF₃ | OMe | F | NO₂ | OMe | CF₃ | Cl | OMe |
| Me | NO₂ | Me | Cl | CF₃ | Me | Cl | NO₂ | Me | NO₂ | Cl | Me |
| Me | NO₂ | F | Cl | CF₃ | F | Cl | NO₂ | F | NO₂ | Cl | F |
| Me | NO₂ | Cl | Cl | CF₃ | Cl | Cl | NO₂ | Cl | NO₂ | Cl | Cl |
| Me | NO₂ | Br | Cl | CF₃ | Br | Cl | NO₂ | Br | NO₂ | Cl | Br |
| Me | NO₂ | CF₃ | Cl | CF₃ | CF₃ | Cl | NO₂ | CF₃ | NO₂ | Cl | CF₃ |
| Me | NO₂ | NO₂ | Cl | CF₃ | NO₂ | Cl | NO₂ | NO₂ | NO₂ | Cl | NO₂ |
| Me | NO₂ | OMe | Cl | CF₃ | OMe | Cl | NO₂ | OMe | NO₂ | Cl | OMe |
| Me | OMe | Me | F | OMe | Me | F | H | Me | CF₃ | Br | Me |
| Me | OMe | F | F | OMe | F | F | H | F | CF₃ | Br | F |
| Me | OMe | Cl | F | OMe | Cl | F | H | Cl | CF₃ | Br | Cl |
| Me | OMe | Br | F | OMe | Br | F | H | Br | CF₃ | Br | Br |
| Me | OMe | CF₃ | F | OMe | CF₃ | F | H | CF₃ | CF₃ | Br | CF₃ |
| Me | OMe | NO₂ | F | OMe | NO₂ | F | H | NO₂ | CF₃ | Br | NO₂ |
| Me | OMe | OMe | F | OMe | OMe | F | H | OMe | CF₃ | Br | OMe |
| Me | H | Me | Cl | OMe | Me | Cl | H | Me | NO₂ | Br | Me |
| Me | H | F | Cl | OMe | F | Cl | H | F | NO₂ | Br | F |
| Me | H | Cl | Cl | OMe | Cl | Cl | H | Cl | NO₂ | Br | Cl |
| Me | H | Br | Cl | OMe | Br | Cl | H | Br | NO₂ | Br | Br |
| Me | H | CF₃ | Cl | OMe | CF₃ | Cl | H | CF₃ | NO₂ | Br | CF₃ |
| Me | H | NO₂ | Cl | OMe | NO₂ | Cl | H | NO₂ | NO₂ | Br | NO₂ |
| Me | H | OMe | Cl | OMe | OMe | Cl | H | OMe | NO₂ | Br | OMe |
| OMe | Me | Me | Br | Me | Me | Br | F | Me | CF₃ | CF₃ | Me |
| OMe | Me | F | Br | Me | F | Br | F | F | CF₃ | CF₃ | F |
| OMe | Me | Cl | Br | Me | Cl | Br | F | Cl | CF₃ | CF₃ | Cl |
| OMe | Me | Br | Br | Me | Br | Br | F | Br | CF₃ | CF₃ | Br |
| OMe | Me | CF₃ | Br | Me | CF₃ | Br | F | CF₃ | CF₃ | CF₃ | CF₃ |
| OMe | Me | NO₂ | Br | Me | NO₂ | Br | F | NO₂ | CF₃ | CF₃ | NO₂ |
| OMe | Me | OMe | Br | Me | OMe | Br | F | OMe | CF₃ | CF₃ | OMe |
| OMe | F | Me | Br | Cl | Me | Br | Br | Me | NO₂ | CF₃ | Me |
| OMe | F | F | Br | Cl | F | Br | Br | F | NO₂ | CF₃ | F |
| OMe | F | Cl | Br | Cl | Cl | Br | Br | Cl | NO₂ | CF₃ | Cl |
| OMe | F | Br | Br | Cl | Br | Br | Br | Br | NO₂ | CF₃ | Br |
| OMe | F | CF₃ | Br | Cl | CF₃ | Br | Br | CF₃ | NO₂ | CF₃ | CF₃ |
| OMe | F | NO₂ | Br | Cl | NO₂ | Br | Br | NO₂ | NO₂ | CF₃ | NO₂ |
| OMe | F | OMe | Br | Cl | OMe | Br | Br | OMe | NO₂ | CF₃ | OMe |
| OMe | Cl | Me | Br | CF₃ | Me | Br | NO₂ | Me | CF₃ | NO₂ | Me |
| OMe | Cl | F | Br | CF₃ | F | Br | NO₂ | F | CF₃ | NO₂ | F |
| OMe | Cl | Cl | Br | CF₃ | Cl | Br | NO₂ | Cl | CF₃ | NO₂ | Cl |
| OMe | Cl | Br | Br | CF₃ | Br | Br | NO₂ | Br | CF₃ | NO₂ | Br |
| OMe | Cl | CF₃ | Br | CF₃ | CF₃ | Br | NO₂ | CF₃ | CF₃ | NO₂ | CF₃ |
| OMe | Cl | NO₂ | Br | CF₃ | NO₂ | Br | NO₂ | NO₂ | CF₃ | NO₂ | NO₂ |
| OMe | Cl | OMe | Br | CF₃ | OMe | Br | NO₂ | OMe | CF₃ | NO₂ | OMe |
| OMe | H | Me | Br | OMe | Me | Br | H | Me | NO₂ | NO₂ | Me |
| OMe | H | F | Br | OMe | F | Br | H | F | NO₂ | NO₂ | F |
| OMe | H | Cl | Br | OMe | Cl | Br | H | Cl | NO₂ | NO₂ | Cl |
| OMe | H | OMe | Br | OMe | Br | Br | H | Br | NO₂ | NO₂ | Br |
| OMe | OMe | CF₃ | Br | OMe | CF₃ | Br | H | CF₃ | NO₂ | NO₂ | CF₃ |
| OMe | OMe | NO₂ | Br | OMe | NO₂ | Br | H | NO₂ | NO₂ | NO₂ | NO₂ |
| OMe | OMe | OMe | Br | OMe | OMe | Br | H | OMe | NO₂ | NO₂ | OMe |
| OMe | Br | Me | OMe | CF₃ | Me | CF₃ | H | Me | CF₃ | OMe | Me |
| OMe | Br | F | OMe | CF₃ | F | CF₃ | H | F | CF₃ | OMe | F |
| OMe | Br | Cl | OMe | CF₃ | Cl | CF₃ | H | Cl | CF₃ | OMe | Cl |
| OMe | Br | Br | OMe | CF₃ | Br | CF₃ | H | Br | CF₃ | OMe | Br |
| OMe | Br | CF₃ | OMe | CF₃ | CF₃ | CF₃ | H | CF₃ | CF₃ | OMe | CF₃ |
| OMe | Br | NO₂ | OMe | CF₃ | NO₂ | CF₃ | H | NO₂ | CF₃ | OMe | NO₂ |
| OMe | Br | OMe | OMe | CF₃ | OMe | CF₃ | H | OMe | CF₃ | OMe | OMe |
| OMe | H | Br | OMe | NO₂ | Me | NO₂ | H | Me | NO₂ | OMe | Me |
| OMe | H | CF₃ | OMe | NO₂ | F | NO₂ | H | F | NO₂ | OMe | F |
| OMe | H | NO₂ | OMe | NO₂ | Cl | NO₂ | H | Cl | NO₂ | OMe | Cl |
| OMe | OMe | Me | OMe | NO₂ | Br | NO₂ | H | Br | NO₂ | OMe | Br |
| OMe | OMe | F | OMe | NO₂ | CF₃ | NO₂ | H | CF₃ | NO₂ | OMe | CF₃ |
| OMe | OMe | Cl | OMe | NO₂ | NO₂ | NO₂ | H | NO₂ | NO₂ | OMe | NO₂ |
| OMe | OMe | Br | OMe | NO₂ | OMe | NO₂ | H | OMe | NO₂ | OMe | OMe |

TABLE 4

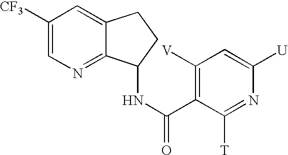

| T | U | V | T | U | V | T | U | V | T | U | V |
|---|---|---|---|---|---|---|---|---|---|---|---|
| Me | Me | Me | F | Me | Me | F | F | Me | CF₃ | Me | Me |
| Me | Me | F | F | Me | F | F | F | F | CF₃ | Me | F |
| Me | Me | Cl | F | Me | Cl | F | F | Cl | CF₃ | Me | Cl |
| Me | Me | Br | F | Me | Br | F | F | Br | CF₃ | Me | Br |
| Me | Me | CF₃ | F | Me | CF₃ | F | F | CF₃ | CF₃ | Me | CF₃ |
| Me | Me | NO₂ | F | Me | NO₂ | F | F | NO₂ | CF₃ | Me | NO₂ |
| Me | Me | OMe | F | Me | OMe | F | F | OMe | CF₃ | Me | OMe |
| Me | F | Me | Cl | Me | Me | Cl | F | Me | NO₂ | Me | Me |
| Me | F | F | Cl | Me | F | Cl | F | F | NO₂ | Me | F |
| Me | F | Cl | Cl | Me | Cl | Cl | F | Cl | NO₂ | Me | Cl |
| Me | F | Br | Cl | Me | Br | Cl | F | Br | NO₂ | Me | Br |
| Me | F | CF₃ | Cl | Me | CF₃ | Cl | F | CF₃ | NO₂ | Me | CF₃ |
| Me | F | NO₂ | Cl | Me | NO₂ | Cl | F | NO₂ | NO₂ | Me | NO₂ |
| Me | F | OMe | Cl | Me | OMe | Cl | F | OMe | NO₂ | Me | OMe |
| Me | Cl | Me | F | Cl | Me | F | Br | Me | CF₃ | F | Me |
| Me | Cl | F | F | Cl | F | F | Br | F | CF₃ | F | F |
| Me | Cl | Cl | F | Cl | Cl | F | Br | Cl | CF₃ | F | Cl |
| Me | Cl | Br | F | Cl | Br | F | Br | Br | CF₃ | F | Br |
| Me | Cl | CF₃ | F | Cl | CF₃ | F | Br | CF₃ | CF₃ | F | CF₃ |
| Me | Cl | NO₂ | F | Cl | NO₂ | F | Br | NO₂ | CF₃ | F | NO₂ |
| Me | Cl | OMe | F | Cl | OMe | F | Br | OMe | CF₃ | F | OMe |
| Me | Br | Me | Cl | Cl | Me | Cl | Br | Me | NO₂ | F | Me |
| Me | Br | F | Cl | Cl | F | Cl | Br | F | NO₂ | F | F |
| Me | Br | Cl | Cl | Cl | Cl | Cl | Br | Cl | NO₂ | F | Cl |
| Me | Br | Br | Cl | Cl | Br | Cl | Br | Br | NO₂ | F | Br |
| Me | Br | CF₃ | Cl | Cl | CF₃ | Cl | Br | CF₃ | NO₂ | F | CF₃ |
| Me | Br | NO₂ | Cl | Cl | NO₂ | Cl | Br | NO₂ | NO₂ | F | NO₂ |
| Me | Br | OMe | Cl | Cl | OMe | Cl | Br | OMe | NO₂ | F | OMe |
| Me | CF₃ | Me | F | CF₃ | Me | F | NO₂ | Me | CF₃ | Cl | Me |
| Me | CF₃ | F | F | CF₃ | F | F | NO₂ | F | CF₃ | Cl | F |
| Me | CF₃ | Cl | F | CF₃ | Cl | F | NO₂ | Cl | CF₃ | Cl | Cl |
| Me | CF₃ | Br | F | CF₃ | Br | F | NO₂ | Br | CF₃ | Cl | Br |
| Me | CF₃ | CF₃ | F | CF₃ | CF₃ | F | NO₂ | CF₃ | CF₃ | Cl | CF₃ |
| Me | CF₃ | NO₂ | F | CF₃ | NO₂ | F | NO₂ | NO₂ | CF₃ | Cl | NO₂ |
| Me | CF₃ | OMe | F | CF₃ | OMe | F | NO₂ | OMe | CF₃ | Cl | OMe |
| Me | NO₂ | Me | Cl | CF₃ | Me | Cl | NO₂ | Me | NO₂ | Cl | Me |
| Me | NO₂ | F | Cl | CF₃ | F | Cl | NO₂ | F | NO₂ | Cl | F |
| Me | NO₂ | Cl | Cl | CF₃ | Cl | Cl | NO₂ | Cl | NO₂ | Cl | Cl |
| Me | NO₂ | Br | Cl | CF₃ | Br | Cl | NO₂ | Br | NO₂ | Cl | Br |
| Me | NO₂ | CF₃ | Cl | CF₃ | CF₃ | Cl | NO₂ | CF₃ | NO₂ | Cl | CF₃ |
| Me | NO₂ | NO₂ | Cl | CF₃ | NO₂ | Cl | NO₂ | NO₂ | NO₂ | Cl | NO₂ |
| Me | NO₂ | OMe | Cl | CF₃ | OMe | Cl | NO₂ | OMe | NO₂ | Cl | OMe |
| Me | OMe | Me | F | OMe | Me | F | H | Me | CF₃ | Br | Me |
| Me | OMe | F | F | OMe | F | F | H | F | CF₃ | Br | F |
| Me | OMe | Cl | F | OMe | Cl | F | H | Cl | CF₃ | Br | Cl |
| Me | OMe | Br | F | OMe | Br | F | H | Br | CF₃ | Br | Br |
| Me | OMe | CF₃ | F | OMe | CF₃ | F | H | CF₃ | CF₃ | Br | CF₃ |
| Me | OMe | NO₂ | F | OMe | NO₂ | F | H | NO₂ | CF₃ | Br | NO₂ |
| Me | OMe | OMe | F | OMe | OMe | F | H | OMe | CF₃ | Br | OMe |
| Me | H | Me | Cl | OMe | Me | Cl | H | Me | NO₂ | Br | Me |
| Me | H | F | Cl | OMe | F | Cl | H | F | NO₂ | Br | F |
| Me | H | Cl | Cl | OMe | Cl | Cl | H | Cl | NO₂ | Br | Cl |
| Me | H | Br | Cl | OMe | Br | Cl | H | Br | NO₂ | Br | Br |
| Me | H | CF₃ | Cl | OMe | CF₃ | Cl | H | CF₃ | NO₂ | Br | CF₃ |
| Me | H | NO₂ | Cl | OMe | NO₂ | Cl | H | NO₂ | NO₂ | Br | NO₂ |
| Me | H | OMe | Cl | OMe | OMe | Cl | H | OMe | NO₂ | Br | OMe |
| OMe | Me | Me | Br | Me | Me | Br | F | Me | CF₃ | CF₃ | Me |
| OMe | Me | F | Br | Me | F | Br | F | F | CF₃ | CF₃ | F |
| OMe | Me | Cl | Br | Me | Cl | Br | F | Cl | CF₃ | CF₃ | Cl |
| OMe | Me | Br | Br | Me | Br | Br | F | Br | CF₃ | CF₃ | Br |
| OMe | Me | CF₃ | Br | Me | CF₃ | Br | F | CF₃ | CF₃ | CF₃ | CF₃ |
| OMe | Me | NO₂ | Br | Me | NO₂ | Br | F | NO₂ | CF₃ | CF₃ | NO₂ |
| OMe | Me | OMe | Br | Me | OMe | Br | F | OMe | CF₃ | CF₃ | OMe |
| OMe | F | Me | Br | Cl | Me | Br | Br | Me | NO₂ | CF₃ | Me |
| OMe | F | F | Br | Cl | F | Br | Br | F | NO₂ | CF₃ | F |
| OMe | F | Cl | Br | Cl | Cl | Br | Br | Cl | NO₂ | CF₃ | Cl |
| OMe | F | Br | Br | Cl | Br | Br | Br | Br | NO₂ | CF₃ | Br |
| OMe | F | CF₃ | Br | Cl | CF₃ | Br | Br | CF₃ | NO₂ | CF₃ | CF₃ |
| OMe | F | NO₂ | Br | Cl | NO₂ | Br | Br | NO₂ | NO₂ | CF₃ | NO₂ |
| OMe | F | OMe | Br | Cl | OMe | Br | Br | OMe | NO₂ | CF₃ | OMe |
| OMe | Cl | Me | Br | CF₃ | Me | Br | NO₂ | Me | CF₃ | NO₂ | Me |
| OMe | Cl | F | Br | CF₃ | F | Br | NO₂ | F | CF₃ | NO₂ | F |
| OMe | Cl | Cl | Br | CF₃ | Cl | Br | NO₂ | Cl | CF₃ | NO₂ | Cl |
| OMe | Cl | Br | Br | CF₃ | Br | Br | NO₂ | Br | CF₃ | NO₂ | Br |
| OMe | Cl | CF₃ | Br | CF₃ | CF₃ | Br | NO₂ | CF₃ | CF₃ | NO₂ | CF₃ |
| OMe | Cl | NO₂ | Br | CF₃ | NO₂ | Br | NO₂ | NO₂ | CF₃ | NO₂ | NO₂ |
| OMe | Cl | OMe | Br | CF₃ | OMe | Br | NO₂ | OMe | CF₃ | NO₂ | OMe |
| OMe | H | Me | Br | OMe | Me | Br | H | Me | NO₂ | NO₂ | Me |
| OMe | H | F | Br | OMe | F | Br | H | F | NO₂ | NO₂ | F |
| OMe | H | Cl | Br | OMe | Cl | Br | H | Cl | NO₂ | NO₂ | Cl |
| OMe | H | OMe | Br | OMe | Br | Br | H | Br | NO₂ | NO₂ | Br |
| OMe | OMe | CF₃ | Br | OMe | CF₃ | Br | H | CF₃ | NO₂ | NO₂ | CF₃ |
| OMe | OMe | NO₂ | Br | OMe | NO₂ | Br | H | NO₂ | NO₂ | NO₂ | NO₂ |
| OMe | OMe | OMe | Br | OMe | OMe | Br | H | OMe | NO₂ | NO₂ | OMe |
| OMe | Br | Me | OMe | CF₃ | Me | CF₃ | H | Me | CF₃ | OMe | Me |
| OMe | Br | F | OMe | CF₃ | F | CF₃ | H | F | CF₃ | OMe | F |
| OMe | Br | Cl | OMe | CF₃ | Cl | CF₃ | H | Cl | CF₃ | OMe | Cl |
| OMe | Br | Br | OMe | CF₃ | Br | CF₃ | H | Br | CF₃ | OMe | Br |
| OMe | Br | CF₃ | OMe | CF₃ | CF₃ | CF₃ | H | CF₃ | CF₃ | OMe | CF₃ |
| OMe | Br | NO₂ | OMe | CF₃ | NO₂ | CF₃ | H | NO₂ | CF₃ | OMe | NO₂ |
| OMe | Br | OMe | OMe | CF₃ | OMe | CF₃ | H | OMe | CF₃ | OMe | OMe |
| OMe | H | Br | OMe | NO₂ | Me | NO₂ | H | Me | NO₂ | OMe | Me |
| OMe | H | CF₃ | OMe | NO₂ | F | NO₂ | H | F | NO₂ | OMe | F |
| OMe | H | NO₂ | OMe | NO₂ | Cl | NO₂ | H | Cl | NO₂ | OMe | Cl |
| OMe | OMe | Me | OMe | NO₂ | Br | NO₂ | H | Br | NO₂ | OMe | Br |
| OMe | OMe | F | OMe | NO₂ | CF₃ | NO₂ | H | CF₃ | NO₂ | OMe | CF₃ |
| OMe | OMe | Cl | OMe | NO₂ | NO₂ | NO₂ | H | NO₂ | NO₂ | OMe | NO₂ |
| OMe | OMe | Br | OMe | NO₂ | OMe | NO₂ | H | OMe | NO₂ | OMe | OMe |

TABLE 5

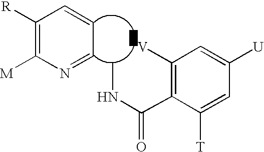

| | | | | | |
|---|---|---|---|---|---|
| J | R | M | J | R | M |

T and V are both Cl and U is H

| | | | | | |
|---|---|---|---|---|---|
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CF₂H | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SCHF₂ | Me |
| CH₂CH₂CH₂ | SCH₂CF₃ | H | CH₂CH₂CH₂ | SCH₂CF₃ | Me |
| CH₂CH₂CH₂ | SCF₂CF₃ | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHFCF₃ | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF₃ | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHFCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)₂Me | H | CH₂CH₂CH₂ | S(O)₂Me | Me |
| CH₂CH₂CH₂ | NO₂ | H | CH₂CH₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHF₂ | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H | Me |
| CH₂CH₂ | OCHFCF₃ | H | CH₂CH₂ | OCHFCF₃ | Me |
| CH₂CH₂ | SCF₃ | H | CH₂CH₂ | SCF₃ | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | SCF₂CF₃ | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFCF₃ | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF₃ | Me |
| CH₂CH₂ | SOCF₂CF₂H | H | CH₂CH₂ | SOCF₂CF₂H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHF₂ | Me |
| CH₂CH₂ | SO₂CH₂CF₃ | H | CH₂CH₂ | SO₂CH₂CF₃ | Me |
| CH₂CH₂ | SO2CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHFCF₃ | Me |
| CH₂CH₂ | CN | H | CH₂CH₂ | CN | Me |
| CH₂CH₂ | SMe | H | CH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(O)₂Me | Me |
| CH₂CH₂ | NO₂ | H | CH₂CH₂ | NO₂₁ | Me |

T and V are both Cl and U is Me

| | | | | | |
|---|---|---|---|---|---|
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHIF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CF₂H | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SCHF₂ | Me |
| CH₂CH₂CH₂ | SCH₂CF₃ | H | CH₂CH₂CH₂ | SCH₂CF₃ | Me |
| CH₂CH₂CH₂ | SCF₂CF₃ | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHFCF₃ | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF₃ | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHFCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)₂Me | H | CH₂CH₂CH₂ | S(O)₂Me | Me |
| CH₂CH₂CH₂ | NO₂ | H | CH₂CH₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHF₂ | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H. | Me |
| CH₂CH₂ | OCHFCF₃ | H | CH₂CH₂ | OCHFCF₃ | Me |
| CH₂CH₂ | SCF₃ | H | CH₂CH₂ | SCF₃ | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | SCF₂CF₃ | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFCF₃ | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF₃ | Me |
| CH₂CH₂ | SOCF₂CF₂H | H | CH₂CH₂ | SOCF₂CF₂H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHP2 | Me |
| CH₂CH₂ | SO₂CH₂CF₃ | H | CH₂CH₂ | SO₂CH₂CF₃ | Me |
| CH₂CH₂ | SO₂CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHIFCF₃ | Me |
| CH₂CH₂ | CN | H | CH₂CH₂ | CN | Me |
| CH₂CH₂ | SMe | H | CH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(Q)2Me | Me |
| CH₂CH₂ | NO₂ | H | CH₂CH₂ | NO₂ | Me |
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CH₂ | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SCHF₂ | Me |
| CH₂CH₂CH₂ | SCH₂CF₃ | H | CH₂CH₂CH₂ | SCH₂CF₃ | Me |
| CH₂CH₂CH₂ | SCF₂CF₃ | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHFCF₃ | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF₃ | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHFCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)₂Me | H | CH₂CH₂CH₂ | S(O)₂Me | Me |
| CH₂CH₂CH₂ | NO₂ | H | CH₂CH₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHF₂ | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H | Me |
| CH₂CH₂ | OCHFCF₃ | H | CH₂CH₂ | OCHF₂CF₃ | Me |
| CH₂CH₂ | SCF₃ | H | CH₂CH₂ | SCF₃ | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | ScF₂CF₃ | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFcF3 | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF₃ | Me |
| CH₂CH₂ | SOCF₂CF₂H | H | CH₂CH₂ | SOCF₂CF₂H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHF₂ | Me |
| CH₂CH₂ | SO₂CH₂CF₃ | H | CH₂CH₂ | SO₂CH₂CF₃ | Me |
| CH₂CH₂ | SO₂CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHFCF₃ | Me |
| CH₂CH₂ | CN | H | CH₂CH₂ | CN | Me |
| CH₂CH₂ | SMe | H | OH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(O)₂Me | Me |
| CH₂CH₂ | NO₂ | H | CH₂CH₂ | NO₂ | Me |

TABLE 6

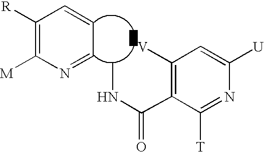

| | | | | | |
|---|---|---|---|---|---|
| J | R | M | J | R | M |

T and V are both Cl and U is H

| | | | | | |
|---|---|---|---|---|---|
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CF₂H | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SCHF₂ | Me |
| CH₂CH₂CH₂ | SCH₂CF₃ | H | CH₂CH₂CH₂ | SCH₂CF₃ | Me |
| CH₂CH₂CH₂ | SCF₂CF₃ | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHFCF₃ | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF₃ | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHTCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)₂Me | H | CH₂CH₂CH₂ | S(O)₂Me | Me |
| CH₂CH₂CH₂ | NO₂ | H | CH₂CH₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHF₂ | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H | Me |
| CH₂CH₂ | OCHFCF₃ | H | CH₂CH₂ | OCHFCF₃ | Me |
| CH₂CH₂ | SCF₃ | H | CH₂CH₂ | SCF₃ | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | SCF₂CF₃ | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFCF₃ | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF₃ | Me |
| CH₂CH₂ | SOCF₂CF₂H | H | CH₂CH₂ | SOCF₂CF₂H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHF₂ | Me |
| CH₂CH₂ | SO₂CH₂CF₃ | H | CH₂CH₂ | SO₂CH₂CF₃ | Me |
| CH₂CH₂ | SO₂CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHFCF₃ | Me |
| CH₂CH₂ | CN | H | CH₂CH₂ | CN | Me |
| CH₂CH₂ | SMe | H | CH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(O)₂Me | Me |
| CH₂CH₂ | NO₂ | H | CH₂CH₂ | NO₂ | Me |

T and V are both Cl and U is Me

| | | | | | |
|---|---|---|---|---|---|
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CF₂H | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SClIF₂ | Me |
| CH₂CH₂CH₂ | SCH₂CF₃ | H | CH₂CH₂CH₂ | SCH₂CF₃ | Me |
| CH₂CH₂CH₂ | SCF₂CF₃ | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHFCF₃ | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF₃ | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHFCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)2Me | H | CH₂CH₂CH₂ | S(O)2Me | Me |
| CH₂CH₂CH₂ | NO₂ | H | CH_{2CH}₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHP2 | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H | Me |
| CH₂CH₂ | OCHFCF₃ | H | CH₂CH₂ | OCHFCF₃ | Me |
| CH₂CH₂ | SCF₃ | H | CH₂CH₂ | SClF3 | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | SCF₂CP3 | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFCF₃ | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF₃ | Me |
| CH₂CH₂ | SOCF₂CF₂H | H | CH₂CH₂ | SOCF₂CF₂H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHF₂ | Me |
| CH₂CH₂ | SO₂CH₂CF₃ | H | CH₂CH₂ | SO₂CH₂CF₃ | Me |
| CH₂CH₂ | SO₂CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHFCF₃ | Me |
| CH₂CH₂ | CN | H | CH₂CH₂ | CN | Me |
| CH₂CH₂ | SMe | H | CH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(O)₂Me | Me |
| CH₂CH₂ | NO₂ | H | CH₂CH₂ | NO₂ | Me |

T is Cl and V and U are both Me

| | | | | | |
|---|---|---|---|---|---|
| CH₂CH₂CH₂ | Cl | H | CH₂CH₂CH₂ | Cl | Me |
| CH₂CH₂CH₂ | Br | H | CH₂CH₂CH₂ | Br | Me |
| CH₂CH₂CH₂ | OCF₃ | H | CH₂CH₂CH₂ | OCF₃ | Me |
| CH₂CH₂CH₂ | OCHF₂ | H | CH₂CH₂CH₂ | OCHF₂ | Me |
| CH₂CH₂CH₂ | OCH₂CF₃ | H | CH₂CH₂CH₂ | OCH₂CF₃ | Me |
| CH₂CH₂CH₂ | OCF₂CF₃ | H | CH₂CH₂CH₂ | OCF₂CF₃ | Me |
| CH₂CH₂CH₂ | OCF₂CF₂H | H | CH₂CH₂CH₂ | OCF₂CF₂H | Me |
| CH₂CH₂CH₂ | OCHFCF₃ | H | CH₂CH₂CH₂ | OCHFCF₃ | Me |
| CH₂CH₂CH₂ | SCF₃ | H | CH₂CH₂CH₂ | SCF₃ | Me |
| CH₂CH₂CH₂ | SCHF₂ | H | CH₂CH₂CH₂ | SCHF₂ | Me |
| CH₂CH₂CH₂ | SCH₂CF₃ | H | CH₂CH₂CH₂ | SCH₂CF₃ | Me |
| CH₂CH₂CH₂ | SCF₂C.F3 | H | CH₂CH₂CH₂ | SCF₂CF₃ | Me |
| CH₂CH₂CH₂ | SCF₂CF₂H | H | CH₂CH₂CH₂ | SCF₂CF₂H | Me |
| CH₂CH₂CH₂ | SCHFCF₃ | H | CH₂CH₂CH₂ | SCHF% | Me |
| CH₂CH₂CH₂ | SOCF₃ | H | CH₂CH₂CH₂ | SOCF₃ | Me |
| CH₂CH₂CH₂ | SOCHF₂ | H | CH₂CH₂CH₂ | SOCHF₂ | Me |
| CH₂CH₂CH₂ | SOCH₂CF₃ | H | CH₂CH₂CH₂ | SOCH₂CF_{3.} | Me |
| CH₂CH₂CH₂ | SOCF₂CF₃ | H | CH₂CH₂CH₂ | SOCF₂CF₃ | Me |
| CH₂CH₂CH₂ | SOCF₂CF₂H | H | CH₂CH₂CH₂ | SOCF₂CF₂H | Me |
| CH₂CH₂CH₂ | SOCHFCF₃ | H | CH₂CH₂CH₂ | SOCHFCF₃ | Me |
| CH₂CH₂CH₂ | SO₂CF₃ | H | CH₂CH₂CH₂ | SO₂CF₃ | Me |
| CH₂CH₂CH₂ | SO₂CHF₂ | H | CH₂CH₂CH₂ | SO₂CHF₂ | Me |
| CH₂CH₂CH₂ | SO₂CH₂CF₃ | H | CH₂CH₂CH₂ | SO₂CH₂CF₃ | Me |
| CH₂CH₂CH₂ | SO₂CF₂CF₃ | H | CH₂CH₂CH₂ | SO₂CF₂CF₃ | Me |
| CH₂CH₂CH₂ | SO₂CF₂CF₂H | H | CH₂CH₂CH₂ | SO₂CF₂CF₂H | Me |
| CH₂CH₂CH₂ | SO₂CHFCF₃ | H | CH₂CH₂CH₂ | SO₂CHFCF₃ | Me |
| CH₂CH₂CH₂ | CN | H | CH₂CH₂CH₂ | CN | Me |
| CH₂CH₂CH₂ | SMe | H | CH₂CH₂CH₂ | SMe | Me |
| CH₂CH₂CH₂ | S(O)Me | H | CH₂CH₂CH₂ | S(O)Me | Me |
| CH₂CH₂CH₂ | S(O)₂Me | H | CH₂CH₂CH₂ | S(O)₂Me | Me |
| CH₂CH₂CH₂ | NO₂ | H | CH₂CH₂CH₂ | NO₂ | Me |
| CH₂CH₂ | Cl | H | CH₂CH₂ | Cl | Me |
| CH₂CH₂ | Br | H | CH₂CH₂ | Br | Me |
| CH₂CH₂ | OCF₃ | H | CH₂CH₂ | OCF₃ | Me |
| CH₂CH₂ | OCHF₂ | H | CH₂CH₂ | OCHF₂ | Me |
| CH₂CH₂ | OCH₂CF₃ | H | CH₂CH₂ | OCH₂CF₃ | Me |
| CH₂CH₂ | OCF₂CF₃ | H | CH₂CH₂ | OCF₂CF₃ | Me |
| CH₂CH₂ | OCF₂CF₂H | H | CH₂CH₂ | OCF₂CF₂H | Me |
| CH₂CH₂ | OCHFCF₃ | H | CH₂CH₂ | OCHFCF₃ | Me |
| CH₂CH₂ | SCF₃ | H | CH₂CH₂ | SCF₃ | Me |
| CH₂CH₂ | SCHF₂ | H | CH₂CH₂ | SCHF₂ | Me |
| CH₂CH₂ | SCH₂CF₃ | H | CH₂CH₂ | SCH₂CF₃ | Me |
| CH₂CH₂ | SCF₂CF₃ | H | CH₂CH₂ | SCF₂CF₃ | Me |
| CH₂CH₂ | SCF₂CF₂H | H | CH₂CH₂ | SCF₂CF₂H | Me |
| CH₂CH₂ | SCHFCF₃ | H | CH₂CH₂ | SCHFCF₃ | Me |
| CH₂CH₂ | SOCF₃ | H | CH₂CH₂ | SOCF₃ | Me |
| CH₂CH₂ | SOCHF₂ | H | CH₂CH₂ | SOCHF₂ | Me |
| CH₂CH₂ | SOCH₂CF₃ | H | CH₂CH₂ | SOCH₂CF₃ | Me |
| CH₂CH₂ | SOCF₂CF₃ | H | CH₂CH₂ | SOCF₂CF_{3~} | Me |
| CH₂CH₂ | SOCF₂CF₂H | H | CH₂CH₂ | SOCF₂CP2H | Me |
| CH₂CH₂ | SOCHFCF₃ | H | CH₂CH₂ | SOCHFCF₃ | Me |
| CH₂CH₂ | SO₂CF₃ | H | CH₂CH₂ | SO₂CF₃ | Me |
| CH₂CH₂ | SO₂CHF₂ | H | CH₂CH₂ | SO₂CHF₂ | Me |
| CH₂CH₂ | SO₂CH₂CF₃ | H | CH₂CH₂ | SO₂CH₂CF₃ | Me |
| CH₂CH₂ | SO₂CF₂CF₃ | H | CH₂CH₂ | SO₂CF₂CF₃ | Me |
| CH₂CH₂ | SO₂CF₂CF₂H | H | CH₂CH₂ | SO₂CF₂CF₂H | Me |
| CH₂CH₂ | SO₂CHFCF₃ | H | CH₂CH₂ | SO₂CHFCF₃ | Me |
| CH₂CH₂ | CN | H | CH₂CH₂ | CN | Me |
| CH₂CH₂ | SMe | H | CH₂CH₂ | SMe | Me |
| CH₂CH₂ | S(O)Me | H | CH₂CH₂ | S(O)Me | Me |
| CH₂CH₂ | S(O)₂Me | H | CH₂CH₂ | S(O)₂Me | Me |
| CH₂CH₂ | NO₂ | H | CH₂CH₂ | NO₂ | Me |

TABLE 7

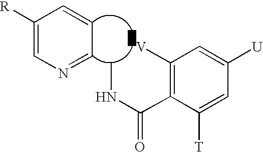

| | | | | | |
|---|---|---|---|---|---|
| J | R | J | R | J | R |

T and V are both Cl and U is H

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂CH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCH₂CH₂ | OCF₃ |
| CH₂CH₂CH₂CH₂ | OCHF₂ | OCH₂ | OCHF₂ | OCH₂CH₂ | OCHF₂ |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCHF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCR3 |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₁NEtCH₂ | Cl | CONHCO | Cl | CONMeCO | Cl |
| CH₂NEtCH₂ | Br | CONHCO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CO₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONHCO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCRF₂ |
| CH₂NEtCH₂ | OCF₃ | CONHCO | OCF₃ | CONMeCO | OCF₃ |
| CH₂NEtCH₂ | SCRF₂ | CONHCO | SCHF₂ | CONMeCO | SCHF₂ |

T and V are both Cl and U is Me

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCH₂CH₂ | OCF₃ |
| CH₂CH₂CH₂CH₂ | OCHF₂ | OCH₂ | OCHF₂ | OCH₂CH₂ | |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCRF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCH₃ |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₂NEtCH₂ | Cl | CONHCO | Cl | CONMeCO | Cl |
| CH₂NEtCH₂ | Br | CONECO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CH₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONECO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCHF₂ |
| CH₂NEtCH₂ | OCF₃ | CONHCO | OCF₃ | CONMeCO | OCF₃ |
| CH₂NEtCH₂ | SCHF₂ | CONHCO | SCHF₂ | CONMeCO | SCHF₂ |

T is Cl and V and U are both Me

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCE2CH₂ | OCF₃ |
| CH₂CH₂CH₂CH₂ | OCHF₂ | OCH₂ | OCHF₂ | OCH₂CH₂ | OCHF₂ |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCHF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCH₃ |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₂NEtCH₂ | Cl | CONHCO | Cl | CONMeCO | Cl |
| CH₂NEtCH₂ | Br | CONHCO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CH₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONHCO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCHF₂ |
| CH₂NEtCH₂ | OCF₃ | CONHCO | OCF₃ | CONMeCO | OCF₃ |
| CH₂NEtCH₂ | SCHF₂ | GONHCO | SCHF₂ | CONMeCO | SCHF₂ |

TABLE 8

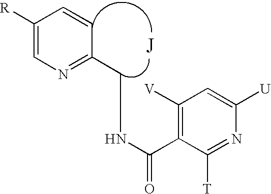

| | | | | | |
|---|---|---|---|---|---|
| J | R | J | R | J | R |

T and V are both Cl and U is H

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCH₂CH₂ | OCF₃ |
| CH₂CH₂CH₂CH₂ | OCHF₂ | OCH₂ | OCHF₂ | OCH₂CH₂ | OCHF₂ |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCHF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCH₃ |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₂NEtCH₂ | Cl | CONHCO | Cl | CONMeCO | Cl |
| CH₂NEtCH₂ | Br | CONHCO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CH₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONHCO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCHF₂ |
| CH₂NEtCH₂ | OCF₃ | CONHCO | OCF₃ | CONMeCO | OCF₃ |
| CH₂NEtCH₂ | SCHF₂ | CONHCO | SCHF₂ | CONMeCO | SCHF₂ |

T and V are both Cl and U is Me

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCH₂CH₂ | OCF₃ |
| CH₂CH₂CH₂CH₂ | OCHF₂ | OCH₂ | OCHF₂ | OCH₂CH₂ | OCHF₂ |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCHF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCH₃ |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₂NEtCH₂ | Cl | CONHCO | Cl | CONMeCO | Cl |
| CH₂NEtCH₂ | Br | CONHCO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CH₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONHCO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCHF₂ |
| CH₂NEtCH₂ | OCF₃ | CONHCO | OCF₃ | CONMeCO | OCF₃ |
| CH₂NEtCH₂ | SCHF₂ | CONHCO | SCHF₂ | CONMeCO | SCHF₂ |

T is Cl and V and U are both Me

| | | | | | |
|---|---|---|---|---|---|
| CH₂CH₂CH₂CH₂ | Cl | OCH₂ | Cl | OCH₂CH₂ | Cl |
| CH₂CH₂CH₂CH₂ | Br | OCH₂ | Br | OCH₂CH₂ | Br |
| CH₂CH₂CH₂CH₂ | CF₃ | OCH₂ | CF₃ | OCH₂CH₂ | CF₃ |
| CH₂CH₂CH₂CH₂ | CO₂CH₃ | OCH₂ | CO₂CH₃ | OCH₂CH₂ | CO₂CH₃ |
| CH₂CH₂CH₂CH₂ | CONHCH₃ | OCH₂ | CONHCH₃ | OCH₂CH₂ | CONHCH₃ |
| CH₂CH₂CH₂CH₂ | I | OCH₂ | I | OCH₂CH₂ | I |
| CH₂CH₂CH₂CH₂ | CH₃ | OCH₂ | CH₃ | OCH₂CH₂ | CH₃ |
| CH₂CH₂CH₂CH₂ | OCF₃ | OCH₂ | OCF₃ | OCH₂CH₂ | OCF₃ |
| CH₂CH₂CH₂CH₂ | OCHF₂ | OCH₂ | OCHF₂ | OCH₂CH₂ | OCHF₂ |
| CH₂CH₂CH₂CH₂ | OCF₃ | OCH₂ | OCF₃ | OCH₂CH₂ | OCF₃ |
| CH₂CH₂CH₂CH₂ | SCHF₂ | OCH₂ | SCHF₂ | OCH₂CH₂ | SCHF₂ |
| OCH₂CH₂CH₂ | Cl | CH₂NHCH₂ | Cl | CH₂NMeCH₂ | Cl |
| OCH₂CH₂CH₂ | Br | CH₂NHCH₂ | Br | CH₂NMeCH₂ | Br |
| OCH₂CH₂CH₂ | CF₃ | CH₂NHCH₂ | CF₃ | CH₂NMeCH₂ | CF₃ |
| OCH₂CH₂CH₂ | CO₂CH₃ | CH₂NHCH₂ | CO₂CH₃ | CH₂NMeCH₂ | CO₂CH₃ |
| OCH₂CH₂CH₂ | CONHCH₃ | CH₂NHCH₂ | CONHCH₃ | CH₂NMeCH₂ | CONHCH₃ |
| OCH₂CH₂CH₂ | I | CH₂NHCH₂ | I | CH₂NMeCH₂ | I |
| OCH₂CH₂CH₂ | CH₃ | CH₂NHCH₂ | CH₃ | CH₂NMeCH₂ | CH₃ |
| OCH₂CH₂CH₂ | OCF₃ | CH₂NHCH₂ | OCF₃ | CH₂NMeCH₂ | OCF₃ |
| OCH₂CH₂CH₂ | OCHF₂ | CH₂NHCH₂ | OCHF₂ | CH₂NMeCH₂ | OCHF₂ |
| OCH₂CH₂CH₂ | OCF₃ | CH₂NHCH₂ | OCF₃ | CH₂NMeCH₂ | OCF₃ |
| OCH₂CH₂CH₂ | SCHF₂ | CH₂NHCH₂ | SCHF₂ | CH₂NMeCH₂ | SCHF₂ |
| CH₂NEtCH₂ | Cl | CONHCO | Cl | CONMeCO | Cl |
| CH₂NEtCH₂ | Br | CONHCO | Br | CONMeCO | Br |
| CH₂NEtCH₂ | CF₃ | CONHCO | CF₃ | CONMeCO | CF₃ |
| CH₂NEtCH₂ | CO₂CH₃ | CONHCO | CO₂CH₃ | CONMeCO | CO₂CH₃ |
| CH₂NEtCH₂ | CONHCH₃ | CONHCO | CONHCH₃ | CONMeCO | CONHCH₃ |
| CH₂NEtCH₂ | I | CONHCO | I | CONMeCO | I |
| CH₂NEtCH₂ | CH₃ | CONHCO | CH₃ | CONMeCO | CH₃ |
| CH₂NEtCH₂ | OCF₃ | CONHCO | OCF₃ | CONMeCO | OCF₃ |
| CH₂NEtCH₂ | OCHF₂ | CONHCO | OCHF₂ | CONMeCO | OCHF₂ |
| CH₂NEtCH₂ | OCF₃ | CONHCO | OCF₃ | CONMeCO | OCF₃ |
| CH₂NEtCH₂ | SCHF₂ | CONHCO | SCHF₂ | CONMeCO | SCHF₂ |

Compositions

This invention also includes fungicidal compositions comprising (1) a fungicidally effective amount of a compound of Formula I (including all geometric And stereoisomers, N-oxides and agriculturally suitable salts thereof); and (2) (i) at least one other insecticide, fungicide, nematocide, bactericide, acaricide, growth regulator, chemosterilant, semiochemical, repellent, attractant, pheromone, feeding stimulant or other biologically active compound; and/or (ii) at least one additional component selected from the group consisting of surfactants, solid diluents and liquid diluents.

Of note are compositions comprising (a) at least one compound of Formula I; and

(b) at least one compound selected from the group consisting of

(b1) alkylenebis(dithiocarbamate) fungicides;

(b2) compounds acting at the bc₁ complex of the fungal mitochondrial respiratory electron transfer site;

(b3) cymoxanil;

(b4) compounds acting at the demethylase enzyme of the sterol biosynthesis pathway;

(b5) morpholine and piperidine compounds that act on the sterol biosynthesis pathway;

(b6) phenylamide fungicides;

(b7) pyrimidinone fungicides;

(b8) phthalimides; and

(b9) fosetyl-aluminum.

The weight ratios of component (b) to component (a) typically is from 100:1 to 1:100, preferably is from 30:1 to 1:30, and more preferably is from 10:1 to 1:10. Of note are compositions wherein the weight ratio of component (b) to component (a) is from 10:1 to 1:1.

The bc₁ Complex Fungicides (component (b2))

Strobilurin fungicides such as azoxystrobin, kresoxim-methyl, metominostrobin/fenominostrobin (SSF-126), picoxystrobin, pyraclostrobin and trifloxystrobin are known to have a fungicidal mode of action which inhibits the bc₁ complex in the mitochondrial respiration chain (Angew. Chem. Int. Ed., 1999, 38, 1328-1349). Methyl (E)-2-[[6-(2-cyanophenoxy)₄-pyrimidinyl]oxy]-α-(methoxyimino)benzeneacetate (also known as azoxystrobin) is described as a bc₁ complex inhibitor in Biochemical Society Transactions 1993, 22, 68S. Methyl (E)-α-(methoxyimino)-2-[(2-methylphenoxy)methyl]benzeneacetate (also known as kresoxim-methyl) is described as a bc₁ complex inhibitor in Biochemical Society Transactions 1993, 22, 64S. (E)-2-[(2,5-Dimethylphenoxy)methyl]-α-(methoxyimino)-N-methylbenzeneacetamide is described as a bc₁ complex inhibitor in Biochemistry and Cell Biology 1995, 85(3), 306-311. Other compounds that inhibit the bc₁ complex in the mitochondrial respiration chain include famoxadone and fenamidone.

The bc₁ complex is sometimes referred to by other names in the biochemical literature, including complex III of the electron transfer chain, and ubihydroquinone:cytochrome c oxidoreductase. It is uniquely identified by the Enzyme Commission number EC1.10.2.2. The bc₁ complex is described in, for example, J. Biol. Chem. 1989, 264, 14543-38; Methods Enzymol. 1986, 126, 253-71; and references cited therein.

The Sterol Biosynthesis Inhibitor Fungicides (Component (4) or (5)

The class of sterol biosynthesis inhibitors includes DMI and non-DMI compounds, that control fungi by inhibiting enzymes in the sterol biosynthesis pathway. DMI fungicides have a common site of action within the fungal sterol biosynthesis pathway; that is, an inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides fall into several classes: azoles (including triazoles and imidazoles), pyrimidines, piperazines and pyridines. The triazoles includes bromuconazole, cyproconazole, difenoconazole, diniconazole, epoxiconazole, fenbuconazole, fluquinconazole, fusilazole, flutriafol, hexaconazole, ipconazole, metconazole, penconazole, propiconazole, tebuconazole, tetraconazole, triadimefon, triadimenol, triticonazole and uniconazole. The imidazoles include clotrimazole, econazole, imazalil, isoconazole, miconazole and prochloraz. The pyrimidines include fenarimol, nuarimol and trarimrol. The piperazines include triforine. The pyridines include buthiobate and pyrifenox. Biochemical investigations have shown that all of the above mentioned fungicides are DNI fungicides as described by K. H. Kuck, et al. in Modern Selective Fungicides—Properties, Applications and Mechanisms of Action, Lyr, H., Ed.; Gustav Fischer Verlag: New York, 1995, 205-258.

The DMI fungicides have been grouped together to distinguish them from other sterol biosynthesis inhibitors, such as, the morpholine and piperidine fungicides. The morpholines and piperidines are also sterol biosynthesis inhibitors but have been shown to inhibit later steps in the sterol biosynthesis pathway. The morpholines include aldimorph, dodemorph, fenpropimorph, tridemorph and trimorphamide. The piperidines include fenpropidin Biochemical investigations have shown that all of the above mentioned morpholine and piperidine fungicides are sterol biosynthesis inhibitor fungicides as described by K H. Kuck, et al. in Modern Selective Fungicides—Properties, Applications and Mechanisms of Action, Lyr, H., Ed.; Gustav Fischer Verlag: New York, 1995, 185-204.

Pyrimidinone Fungicides (Component (b7))

Pyrimidinone fungicides include compounds of Formula II

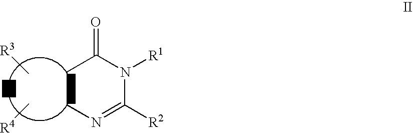

wherein

G is a fused phenyl, thiophene or pyridine ring;

R¹ is C₁-C₆ alkyl;

R² is C₁-C₆ alkyl or C₁-C₆ alkoxy;

R³ is halogen; and

R⁴ is hydrogen or halogen.

Pyrimidinone fungicides are described in International Patent Application WO94/26722, U.S. Pat. No. 6,066,638, U.S. Pat. No. 6,245,770, U.S. Pat. No. 6,262,058 and U.S. Pat. No. 6,277,858.

Of note are pyrimidinone fungicides selected from the group:

6-bromo-3-propyl-2-propyloxy-4(3H)-quinazolinone,

6,8-diiodo-3-propyl-2-propyloxy-4(3H)-quinazolinone,

6-iodo-3-propyl-2-propyloxy-4(3H)-quinazolinone,

6-chloro-2-propoxy-3-propylthieno[2,3-d]pyrimidin-4(3H)-one,

6-bromo-2-propoxy-3-propylthieno [2,3-d]pyrimidin-4(3H)-one,

7-bromo-2-propoxy-3-propylthieno[3,2-d]pyrimidin-4(3H)-one,

6-bromo-2-propoxy-3-propylpyrido [2,3-d]pyrimidin-4(3H)-one,

6,7-dibromo-2-propoxy-3-propylthieno[3,2-d]pyrimidin-4(3H)-one, and

3-(cyclopropylmethyl)-6-iodo-2-(propylthio)pyrido[2,3-d]pyrimidin-4(3H)-one.

TABLE 9
Examples of component (b)

| | |
|---|---|
| (b1) | Alkylenebis(dithiocarbamate)s such as mancozeb, maneb, propineb |
| | and zineb |
| (b3) | Cymoxanil |
| (b6) | Phenylamides such as metalaxyl, benalaxyl and oxadixyl |
| (b8) | Phthalimids such as folpet or captan |
| (b9) | Fosetyl-aluminum |

Other fungicides that can be included in compositions of this invention in combination with a Formula I compound or as an additional component in combination with component (a) and component (b) are acibenzolar, benalaxyl, benomyl, blasticidin-S, Bordeaux mixture (tribasic copper sulfate), carpropamid, captafol, captan, carbendazim, chloroneb, chlorothalonil, copper oxychloride, copper salts such as copper sulfate and copper hydroxide, cyazofamid, cymoxanil, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, dimethomorph, diniconazole-M, dodemorph, dodine, edifenphos, fencaramid (SZX0722), fenpiclonil, fentin acetate, fentin hydroxide, fluazinam, fludioxonil, flumetover (RPA 403397), flutolanil, folpet, fosetyl-aluminum, furalaxyl, furametapyr (S-82658), iprobenfos, iprodione, isoprothiolane, iprovalicarb, kasugamycin, mancozeb, maneb, mefenoxam, mepronil, metalaxyl, metiram-zinc, myclobutanil, neo-asozin (ferric methanearsonate), oxadixyl, pencycuron, prochloraz, procymidone, propamocarb, propineb, pyrifenox, pyrimethanil, pyroquilon, quinoxyfen, spiroxamine, sulfur, thifluzamide, thiophanate-methyl, thiram, triadimefon, tricyclazole, validamycin, vinclozolin, zineb and zoxamid.

Descriptions of the commercially available compounds listed above may be found in The Pesticide Manual, Twelfth Edition, C. D. S. Tomlin, ed., British Crop Protection Council, 2000.

Of note are combinations of Formula I with fungicides of a different biochemical mode of action (e.g. mitochondrial respiration inhibition, inhibition of protein synthesis by interference of the synthesis of ribosomal RNA or inhibition of beta-tubulin synthesis) that can be particularly advantageous for resistance management. Examples include combinations of compounds of Formula I (e.g. Compound 1) with strobilurins such as azoxystrobin, kresoxim-methyl, pyraclostrobin and trifloxystrobin; carbendazim, mitochondrial respiration inhibitors such as famoxadone and fenamidone; benomyl, cymoxanil; dimethomorph; folpet; fosetyl-aluminum; metalaxyl; mancozeb and maneb. These combinations can be particularly advantageous for resistance management, especially where the fungicides of the combination control the same or similar diseases.

Of note are combinations of Formula I with fungicides for controlling grape diseases (e.g. Plasmopara viticola, Botrytis cinerea and Uncinula necatur) including alkylenebis(dithiocarbamate)s such as mancozeb, maneb, propineb and zineb, phthalimids such as folpet, copper salts such as copper sulfate and copper hydroxide, strobilurins such as azoxystrobin, pyraclostrobin and trifloxystrobin, mitochondrial respiration inhibitors such as famoxadone and fenamidone, phenylamides such as metalaxyl, phosphonates such as fosetyl-Al, dimethomorph, pyrimidinone fungicides such as 6-iodo-3-propyl-2-propyloxy-4(3H)-quinazolinone and 6-chloro-2-propoxy-3-propylthieno[2,3-d]pyrimidin-4(3H)-one, and other fungicides such as cymoxanil.

Of note are combinations of Formula I with fungicides for controlling potato diseases (e.g. Phytophthora infestans, Alternaria solani and Rhizoctonia solani) including alkylenebis(dithiocarbamate)s such as mancozeb, maneb, propineb and zineb; copper salts such as copper sulfate and copper hydroxide; strobilurins such as pyraclostrobin and trifloxystrobin; mitochondrial respiration inhibitors such as famoxadone and fenamidone; phenylamides such as metalaxyl; carbamates such as propamocarb; phenylpyridylamines such as fluazinam and other fungicides such as chlorothalonil, cyazofarrid, cymoxanil, dimethomorph, zoxamid and iprovalicarb.

Of note are compositions wherein component (b) comprises at least one compound from each of two different groups selected from (b1), (b2), (b3), (b4), (b5), (b6), (b7), (b8) and (b9). The weight ratio of the compound(s) of the first of these two component (b) groups to the compound(s) of the second of these component (b) groups typically is from 100:1 to 1:100, more typically from 30:1 to 1:30 and most typically from 10:1 to 1:10.

Of note are compositions wherein component (b) comprises at least one compound selected from (b1), for example mancozeb, and at least one compound selected from a second component (b) group, for example, from (b2), (b3), (b6), (b7), (b8) or (b9). Of particular note are such compositions wherein the overall weight ratio of component (b) to component (a) is from 30:1 to 1:30 and the weight ratio of component (b1) to component (a) is from 10:1 to 1:1. Examples of these compositions include compositions comprising mixtures of component (a) (preferably a compound from Index Table A, B or C) with mancozeb and a compound selected from the group consisting of famoxadone, fenamidone, azoxystrobin, kresoxim-methyl, pyraclostrobin, trifloxystrobin, cymoxanil, metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises at least one compound selected from (b2), for example famoxadone, and at least one compound selected from a second component (b) group, for example, from (b1), (b3), (b6), (b7), (b8) or (b9). Of particular note are such compositions wherein the overall weight ratio of component (b) to component (a) is from 30:1 to 1:30 and the weight ratio of component (b2) to component (a) is from 10:1 to 1:1. Examples of these compositions include compositions comprising mixtures of component (a) (preferably a compound from Index Table A, B or C) with famoxadone and a compound selected from the group consisting of mancozeb, maneb, propineb, zineb, cymoxanil, metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises the compound of (b3), in other words cymoxanil, and at least one compound selected from a second component (b) group, for example, from (b1)), (b2), (b6), (b7), (b8) or (b9). Of particular note are such compositions wherein the overall weight ratio of component (b) to component (a) is from 30:1 to 1:30 and the weight ratio of component (b3) to component (a) is from 10:1 to 1:1. Examples of these compositions include compositions comprising mixtures of component (a) (preferably a compound from Index Table A, B or C) with cymoxanil and a compound selected from the group consisting of famoxadone, fenamidone, azoxystrobin, kresoxim-methyl, pyraclostrobin, trifloxystrobin, mancozeb, maneb, propineb, zineb, metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises at least one compound selected from (b6), for example metalaxyl, and at least one compound selected from a second component (b) group, for example, from (b1), (b2), (b3), (b7), (b8) or (b9). Of particular note are such compositions wherein the overall weight ratio of component (b) to component (a) is from 30:1 to 1:30 and the weight ratio of component (b6) to component (a) is from 10:1 to 1:3. Examples of these compositions include compositions comprising mixtures of component (a) (preferably a compound from Index Table A, B or C) with metalaxyl or oxadixyl and a compound selected from the group consisting of famoxadone, fenamidone, azoxystrobin, kresoxim-methyl, pyraclostrobin, trifloxystrobin, cymoxanil, mancozeb, maneb, propineb, zineb, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises at least one compound selected from (b7), for example 6-iodo-3-propyl-2-propyloxy-4(3H)-quinazolinone or 6-chloro-2-propoxy-3-propylthieno[2,3-d]pyrimidin-4(3H)-one, and at least one compound selected from a second component (b) group, for example, from (b1), (b2), (b3), (b6), (b8) or (b9). Of particular note are such compositions wherein the overall weight ratio of component (b) to component (a) is from 30:1 to 1:30 and the weight ratio of component (b7) to component (a) is from 1:1 to 1:20. Included are compositions wherein the weight ratio of component (b6) to component (a) is from 1:4.5 to 1:9. Examples of these compositions include compositions comprising mixtures of component (a) (preferably a compound from Index Table A, B or C) with 6-iodo-3-propyl-2-propyloxy-4(3H)-quinazolinone or 6-chloro-2-propoxy-3-propylthieno[2,3-d]pyrimidin-4(3H)-one and a compound selected from the group consisting of famoxadone, fenamidone, azoxystrobin, kresoxim-methyl, pyraclostrobin, trifloxystrobin, cymoxanil, mancozeb, maneb, propineb, zineb, metalaxyl, benalaxyl, oxadixyl, folpet, captan and fosetyl-aluminum.

Also of note are compositions wherein component (b) comprises the compound of (b9), in other words fosetyl-aluminum, and at least one compound selected from a second component (b) group, for example, from (b1), (b2), (b3), (b6) or (b7). Of particular note are such compositions wherein the overall weight ratio of component (b) to component (a) is from 30:1 to 1:30 and the weight ratio of component (b9) to component (a) is from 10:1 to 1:1. Examples of these compositions include compositions comprising mixtures of component (a) (preferably a compound from Index Table A, B or C) with fosetyl-aluminum and a compound selected from the group consisting of famoxadone, fenamidone, azoxystrobin, kresoxim-methyl, pyraclostrobin, trifloxystrobin, mancozeb, maneb, propineb, zineb, metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and cymoxanil.

Of note are combinations of compounds of Formula I with fungicides giving an even broader spectrum of agricultural protection including strobilurins such as azoxystrobin, kresoxim-methyl, pyraclostrobin and trifloxystrobin; morpholines such as fenpropidine and fenpropimorph; triazoles such as bromuconazole, cyproconazole, difenoconazole, epoxyconazole, flusilazole, ipconazole, metconazole, propiconazole, tebuconazole and triticonazole; pyrimidinone fungicides, benomyl; carbendazim; chlorothalonil; dimethomorph; folpet; mancozeb; maneb; quinoxyfen; validamycin and vinclozolin.

Of note are combinations with other fungicides giving an even broader spectrum of agricultural protection including azoxystrobin, kresoxim-methyl, pyrclostrobin, trifloxystrobin, benomyl, carbendazim, chlorothalonil, dimethomorph, folpet, mancozeb, maneb, quinoxyfen, validamycin, vinclozolin, fenpropidine, fenpropimorph, bromuconazole, cyproconazole, difenoconazole, epoxyconazole, flusilazole, ipconazole, metconazole, propiconazole, tebuconazole and triticonazole.

Of note are combinations with other fungicides of a different mode of action (e.g. mitochondrial respiration inhibition, inhibition of protein synthesis by interference of the synthesis of ribosomal RNA or inhibition of beta-tubulin synthesis) that can be particularly advantageous for resistance management. Examples include combinations of compounds of Formula I (e.g. Compound A1) with azoxystrobin, kresoxim-methyl, pyrclostrobin, trifloxystrobin, carbendazim, famoxadone, fenamidone, benomyl, cymoxanil, dimethomorph, folpet, fosetyl-aluminum, metalaxyl, mancozeb, maneb. These combinations can be particularly advantageous for resistance management, especially where the fungicides of the combination control the same or similar diseases.

Of note are combinations with other fungicides for controlling grape diseases including dithiocarbamates such as mancozeb, maneb, propineb and zineb, phthalimids such as folpet, copper salts such as copper sulfate and copper hydroxide, strobilurins such as azoxystrobin, pyrclostrobin and trifloxystrobin, , phenylamides such as metalaxyl, phosphonates such as fosetyl-aluminum, morpholines such as dimethomorph, and other fungicides such as cymoxanil, famoxadone and fenamidone.

Of note are combinations with other fungicides for controlling potato diseases including dithiocarbamates such as mancozeb, maneb, propineb and zineb, copper salts such as copper sulfate and copper hydroxide, strobilurins such as pyrclostrobin and trifloxystrobin, phenylamides such as metalaxyl, carbamates such as propamocarb, phenylpyriylamines such as fluazinam, morpholines such as dimethomorph, and other fungicides such as chlorothalonil, cyazofamid, cymoxanil, famoxadone, fenamidone, zoxamid and iprovalicarb.

Of particular note are combinations of Compound A1 with azoxystrobin, combinations of Compound A1 with kresoxim-methyl, combinations of Compound A1 with pyrclostrobin, combinations of Compound 1 with trifloxystrobin, combinations of Compound 1 with carbendazim, combinations of Compound A1 with chlorothalonil, combinations of Compound A1 with dimethomorph, combinations of Compound A1 with folpet, combinations of Compound A1 with mancozeb, combinations of Compound A1 with maneb, combinations of Compound A1 with quinoxyfen, combinations of Compound A1 with validamycin, combinations of Compound A1 with vinclozolin, Compound A1 with fenpropidine, Compound A1 with fenpropimorph, Compound A1 with bromuconazole, Compound A1 with cyproconazole, Compound A1 with difenoconazole, Compound A1 with epoxyconazole, Compound A1 with flusilazole, Compound A1 with ipconazole, Compound A1 with metconazole, Compound A1 with propiconazole, Compound A1 with tebuconazole, Compound A1 with triticonazole, Compound A1 with famoxadone, Compound A1 with fenamidone, Compound A1 with benomyl, Compound A1 with cymoxanil, Compound A1 with dimethomorph, Compound A1 with folpet, Compound A1 with fosetyl-aluminum, Compound A1 with metalaxyl, Compound A1 with Compound A1 with propineb, Compound A1 with zineb, Compound A1 with copper sulfate, Compound A1 with copper hydroxide, Compound A1 with propamocarb, Compound A1 with cyazofamid, Compound A1 with zoxamid and Compound A1 with iprovalicarb. Compound numbers refer to compounds in Index Tables A-D.

Preferred 15. Preferred compositions comprise a compound of component (a) mixed with cymoxanil.

Preferred 16. Preferred compositions comprise a compound of component (a) mixed with a compound selected from (b1). More preferred is a composition wherein the compound of (b1) is mancozeb.

Preferred 17. Preferred compositions comprise a compound of component (a) mixed with a compound selected from (b2). More preferred is a composition wherein the compound of (b2) is famoxadone.

Preferred compositions comprise a compound of component (a) mixed with two compounds selected from two different groups selected from (b1), (b2), (b3), (b4), (bS), (b6), (b7), (b8) and (b9).

Preferred compositions are those wherein component (a) is selected from the compounds of Formula I indicated in Preferred 1 through 14 above.

Compounds of this invention can also be mixed with one or more insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which compositions of this invention can be formulated are: insecticides such as abamectin, acephate, azinphos-methyl bifenthrin, buprofezin, carbofuran, chlorfenapyr, chlorpyrifos, chlorpyrifos-methyl, cyfluthrin, beta-cyfluthrin, cyhalothrn, lambda-cyhalothrin, deltamettrin, diafenthiuron, diazinon, diflubenzuron, dimethoate, esfenvalerate, fenoxycarb, fenpropathrin, fenvalerate, fipronil, flucythrinate, tau-fluvalinate, fonophos, imidacloprid, isofenphos, malathion, metaldehyde, methamidophos, methidathion, methomyl, methoprene, methoxychlor, methyl 7-chloro-2,5-dihydro-2-[[N-(methoxycarbonyl)-N-[4-(trifluoromethoxy)phenyl]amino]carbonyl]indeno[1,2-e][1,3,4]oxadiazine-4a(3H)-carboxylate (indoxacarb), monocrotophos, oxamyl, parathion, parathion-methyl, permethrin, phorate, phosalone, phosmet, phosphamidon, pirimicarb, profenofos, rotenone, sulprofos, tebufenozide, tefluthrin, terbufos, tetrachlorvinphos, thiodicarb, tralomethrin, trichlorfon and triflumuron; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; nematocides such as aldoxycarb and fenamiphos; and biological agents such as Bacillus thuringiensis, Bacillus thuringiensis delta endotoxin, baculovirus, and entomopathogenic bacteria, virus and fungi. The weight ratios of these various mixing partners to compounds of Formula I of this invention typically are between 100:1 and 1:100, preferably between 30:1 and 1:30, more preferably between 10:1 and 1:10 and most preferably between 4:1 and 1:4.

Descriptions of the commercially available compounds listed above may be found in The Pesticide Manual, Twelfth Edition, C. D. S. Tomin, ed., British Crop Protection Council, 2000.

Formulation

Compounds of this invention will generally be used as a formulation or composition with an agriculturally suitable carrier comprising at least one of a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts (e.g. from 0.01-99.99 weight percent) of active ingredient together with diluent and/or surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 5-90 | 0-94 | 1-15 |
| soluble Granules, Tablets and | | | |
| Powders. | | | |
| Suspensions, Emulsions, Solutions | 5-50 | 40-95 | 0-25 |
| (including Emulsifiable | | | |
| Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N. J. Typical liquid diluents are described in Marsden, Solvents Guide, 2nd Ed, Interscience, New York, 1950. McCutcheon 's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofirfiryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Preferred suspension concentrates include those containing, in addition to the active ingredient, from 5 to 20% nonionic surfactant (for example, polyethoxylated fatty alcohols) optionally combined with 50-65% liquid diluents and up to 5% anionic surfactants. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York,-1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed, Blackwell Scientific Publications, Oxford, 1989.

In the following Examples, all percentages are by weight and all formulations are prepared in conventional ways. Compound numbers refer to compounds in Index Tables A-D.

### EXAMPLE A

Wettable Powder

| | |
|---|---|
| Compound A1 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| Compound A1 | 10.0% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| Compound A1 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| Compound A1 | 20.0% |
| blend of oil soluble sulfonates | 10.0% |
| and polyoxyethylene ethers | |
| isophorone | 70.0%. |

### EXAMPLE E

| | | |
|---|---|---|
| Compound A1 | | 20.0% |
| polyethoxylated fatty alcohol | nonionic surfactant | 15.0% |
| ester derivative of montan wax | | 3.0% |
| calcium lignosulfonate | anionic surfactant | 2.0% |
| polyethoxylated/polypropoxylated | | |
| polyglycol block copolymer | surfactant | 1.0% |
| propylene glycol | diluent | 6.4% |
| poly(dimethylsiloxane) | antifoam agent | 0.6% |
| antimicrobial agent | | 0.1% |
| water | diluent | 51.9% |

The formulation ingredients are mixed together as a syrup, Compound A1 is added and the mixture is homogenized in a blender. The resulting slurry is then wet-milled to form a suspension concentrate.

Utility

The compounds and compositions of Formula I are useful as plant disease control agents. The present invention therefore comprises a method for controlling plant diseases caused by fungal plant pathogens comprising applying to the plant or portion thereof to be protected, or to the plant seed or seedling to be protected, an effective amount of a compound of the invention or a fungicidal composition containing said compound.

The preferred methods of use are those involving the compounds or compositions preferred above.

The compounds and compositions of Formula I provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops. These pathogens include Plasmopara viticola, Phytophthora infestayis, Peronospora tabacina, Pseudoperonospora cubensis, Pythium aphamidermatum, Alternaria brassicae, Septoria nodorum, Septoria tritici, Cercosporidium personatum, Cercospora arachidicola, Pseudocercosporella herpotrichoides, Cercospora beticola, Botrytis cinerea, Monilinia fructicola, Pyricularia oryzae, Podosphaera leucotricha, Venturia inaequalis, Erysiphe graminis, Uncinula necatur, Puccinia recondita, Puccinia graminis, Hemileia vastatrix, Puccinia striiformis, Puccinia arachidis, Rhizoctonia solani, Sphaerotheca fuliginea, Fusarium oxysporum, Verticillium dahliae, Pythium aphanidermatum, Phytophthora megasperma, Sclerotinia sclerotiorum, Sclerotium rolfti, Erysiphepolygoni, Pyrenophora teres, Gaeumannomyces graminis, Rynchosporium secalis, Fusarium roseumrn, Bremia lactucae and other generea and species closely related to these pathogens. The compositions of the invention are especially effective in controlling Plasmopara viticola on grapes and Phytophthora infestans on potatoes and tomatoes.

Plant disease control is ordinarily accomplished by applying an effective amount of a compound of Formula I either pre- or post-infection, to the portion of the plant to be protected such as the roots, stems, foliage, fruit, seeds, tubers or bulbs, or to the media (soil or sand) in which the plants to be protected are growing. The compounds can also be applied to the seed to protect the seed and seedling.

Rates of application for these compounds can be influenced by many factors of the environment and should be determined under actual use conditions. Foliage can normally be protected when treated at a rate of from less than 1 g/ha to 5,000 g/ha of active ingredient. Seed and seedlings can normally be protected when seed is treated at a rate of from 0.1 to 10 g per kilogram of seed

The following TESTS demonstrate the control efficacy of compounds suitable for use in accordance with this invention on specific pathogens. The pathogen control protection afforded by the compounds is not limited, however, to these species. These TESTS can also be used to demonstrate the control efficacy of compositions of this invention on specific pathogens. Test suspensions comprising a single active ingredient are sprayed to demonstrate the control efficacy of the active ingredient individually. To demonstrate the control efficacy of a combination, (a) the active ingredients can be combined in the appropriate amounts in a single test suspension, (b) stock solutions of individual active ingredients can be prepared and then combined in the appropriate ratios and diluted to the final desired concentration to form a test suspension or (c) test suspensions comprising single active ingredients can be sprayed sequentially in the desired ratio.

Synergism has been described as “the cooperative action of two components [e.g. component (a) and component (b)] of a mixture, such that the total effect is greater or more prolonged than the sum of the effects of the two (or more) taken independently” (see Tames, P. M. L., Neth. J. Plant Pathology, 1964, 70, 73-80). The presence of a synergistic effect between two active ingredients is established with the aid of the Colby equation (see Colby, S. R. In Calculating Synergistic and Antagonistic Responses of Herbicide Combinations, Weeds, 1967, 15, 20-22):

$$p = A + B - [ \frac{A \times B}{100} ]$$

Using the methods of Colby, the presence of a synergistic interaction between two active ingredients is established by first calculating the predicted activity, p, of the mixture based on activities of the two components applied alone. If p is lower than the experimentally established effect, synergism has occurred. In the equation above, A is the fungicidal activity in percentage control of one component applied alone at rate x. The B term is the fungicidal activity in percentage control of the second component applied at rate y. The equation estimates p, the fungicidal activity of the mixture of A at rate x with B at rate y if their effects are strictly additive and no interaction has occurred.

See Index Tables A-D for descriptions of compound suitable for use in this invention. The following abbreviations are used in the Index Tables that follow: Me is methyl Et is ethyl, Ph is phenyl, OMe is methoxy, OEt is ethoxy. The abbreviation “Ex.” stands for “Example” and is followed by a number indicating in which example the compound is prepared.

INDEX TABLE A

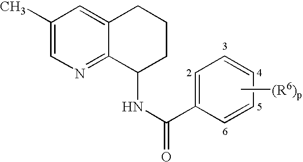

| Compound Number | (R⁶)ₚ | |
|---|---|---|
| A1 (Ex. 1) | 2,6-Cl₂ | * |
| A2 | 4-Br | * |
| A3 | 2-CF₃ | * |
| A4 | 2,6-F₂ | * |
| A5 | 2-Cl | * |
| A6 | 2,4,6-Cl₃ | * |
| A7 | 2-Me | * |
| A8 | 2,3,6-F₃ | * |
| A9 | 2-Cl,6-F | * |
| A10 | 2,6-(OMe)₂ | * |

* See Index Table D for ¹H NMR spectral data

INDEX TABLE B

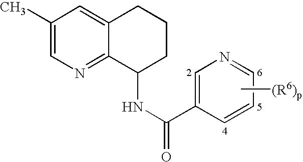

| Compound Number | (R⁶)ₚ | |
|---|---|---|
| B1 | 2-NH(3-CF₃-Ph) | * |
| B2 | 2-SPh | * |
| B3 | 2-SMe | * |
| B4 | 6-Cl | * |
| B5 | 2-OPh | * |
| B6 | 2-OEt | * |
| B7 | 2,4-Cl₂ | * |
| B8 | 2-OH | * |

* See Index Table D for ¹H NMR spectral data

INDEX TABLE C

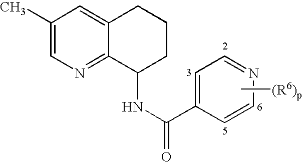

| Compound Number | (R⁶)ₚ | |
|---|---|---|
| C1 | 2-Cl | * |
| C2 | 2-Cl-6-OMe | * |

* See Index Table D for ¹H NMR spectral data

INDEX TABLE D

| Cmpd No. | ¹H NMR Data (300mHz; CDCl₃ solution unless indicated otherwise)^{a} |
|---|---|
| A1 | δ 8.22(s, 1H), 7.30(s, 1H), 7.36-7.23(m, 3H), 6.99(bs, 1H), 5.03(m, 1H), 2.82(m, 3H), 2.29(s, |
| | 3H), 1.94(m, 3H) |
| A2 | δ 8.24(S, 1H), 7.71(d, J=8.7Hz, 2H), 7.58(d, J=8.6Hz, 2H), 7.33(bs, 1H), 7.27(s, 1H), 4.97 |
| | (m, 1H), 2.82(m, 3H), 2.31(s, 3H), 1.95(m, 2H), 1.69(m, 1H) |
| A3 | δ 8.20(s, 1H), 7.68(m, 2H), 7.55(m, 2H), 7.25(s, 1H), 6.87(bs, 1H), 5.02(m, 1H), 2.81(t, |
| | J=6.4Hz, 2H), 2.70(m, 1H), 2.29(s, 3H), 1.94(m, 2H), 1.79(m, 1H) |
| A4 | δ 8.23(s, 1H), 7.35(m, 1H), 7.26(s, 1H), 7.08(bs, 1H), 6.69(d, J=8.1Hz, 1H), 6.91(d, J=8.3Hz, |
| | 1H), 5.02(m, 1H), 2.81(m, 2H), 2.74(m, 1H), 2.29(s, 3H), 1.95(m, 2H), 1.82(m, 1H) |
| A5 | δ 8.24(s, 1H), 7.74(m, 1H), 7.34(m, 3H), 7.26(s, 1H), 7.15(bs, 1H), 5.10(m, 1H), 2.82(m, |
| | 2H), 2.70(m, 1H), 2.29(s, 3H), 195(m, 3H) |
| A6 | δ 8.21(s, 1H), 7.35(s, 2H), 7.24(s, 1H), 6.98(bs, 1H), 4.98(m, 1H), 2.80(m, 3H), 2.29(s, 3H), |
| | 1.95(m, 2H), 1.83(m, 1H) |
| A7 | δ 8.22(s, 1H), 7.48(d, J=7.7Hz, 1H), 7.22(m, 4H), 6.82(bs, 1H), 5.03(m, 1H), 2.81(t, J=6.41Hz, |
| | 2H), 2.71(m, 1H), 2.52(s, 3H), 2.29(s, 3H), 1.94(m, 2H), 1.78(m, 1H) |
| A8 | δ 8.22(s, 1H), 7.26(s, 1H), 7.19(m, 1H), 7.13(bs, 1H), 6.87(m, 1H), 5.02(m, 1H), 2.82(t, |
| | J=6.4Hz, 2H), 2.76(m, 1H), 2.30(s, 3H), 1.95(m, 2H), 1.78(m, 1H) |
| A9 | δ 8.22(s, 1H), 7.25(m, 3H), 7.04(t, J=8.4Hz, 1H), 7.00(bs, 1H), 5.02(m, 1H), 2.82(m, 3H), |
| | 2.27(s, 3H), 1.95(m, 2H), 1.82(m, 1H) |
| A10 | δ 8.23(s, 1H), 7.24(m, 2H), 6.79(bs, 1H), 6.55(m, 2H), 5.03(m, 1H), 3.82(s, 6H), 2.79(m, |
| | 2H), 2.71(m, 1H), 2.28(s, 3H), 1.92(m, 3H) |
| B1 | δ 10.8(s, 1H), 8.35(m, 1H), 8.25(s, 1H), 8.07(s, 1H), 7.86(m, 2H), 7.41(m, 2H), 7.29(m, 1H), |
| | 6.77(m, 1H), 4.98(m, 1H), 2.85(m, 2H), 2.72(m, 1H), 2.32(s, 3H), 1.98(m, 2H), 1.72(m, 1H) |
| B2 | δ 8.37(m, 1H), 8.24(s, 1H), 7.91(m, 1H), 7.52(m, 2H), 7.37(m, 4H), 7.27(s, 1H), 7.07(m, |
| | 1H), 5.07(m, 1H), 2.82(m, 3H), 2.31(s, 3H), 198(m, 2H), 1.80(m, 1H) |
| B3 | δ 9.07(bs, 1H), 8.51(m, 1H), 8.24(s, 1H), 7.90(m, 1H), 7.28(s, 1H), 7.05(m, 1H), 5.03(m, |
| | 1H), 2.83(m, 2H), 2.72(m, 1H), 2.55(s, 3H), 2.30(s, 3H), 1.97(m, 2H), 1.86(m, 1H) |
| B4 | δ 8.81(d, J=2.6Hz, 1H), 8.24(s, 1H), 8.12(dd, J=2.6, 8.3Hz, 1H), 7.56(bs, 1H), 7.37(d, J=8.3Hz, |
| | 1H), 7.32(s, 1H), 5.02(m, 1H), 2.85(m, 2H), 2.72(m, 1H), 2.33(s, 3H), 1.97(m, 2H), 1.78 |
| | (m, 1H) |
| B5 | δ 9.36(bs, 1H), 8.67(dd, J=1.9, 7.5Hz, 1H), 8.21(m, 1H), 8.15(s, 1H), 7.44(m, 1H), 7.23(m, |
| | 6H), 5.12(m, 1H), 2.80(m, 3H), 2.25(s, 3H), 1.95(m, 2H), 1.74(m, 1H) |
| B6 | δ 9.03(bs, 1H), 8.58(dd, J=2.1, 7.5Hz, 1H), 8.29(s, 1H), 8.23(dd, J=2.1, 4.9Hz, 1H), 7.28(s, |
| | 1H), 7.03(dd, J=4.9, 7.5Hz, 1H), 5.10(m, 1H), 4.51(m, 2H), 2.83(m, 2H), 2.70(m, 1H), 2.32 |
| | (s, 3H), 1.95(m, 2H), 1.78(m, 1H), 1.39(t, J=7.1Hz, 3H) |
| B7 | δ 8.29(d, J=5.4Hz, 1H), 8.21(s, 1H), 7.31(d, J=5.4Hz, 1H), 7.26(s, 1H), 7.12(bs, 1H), 5.02 |
| | (m, 1H), 2.82(m, 3H), 2.29(s, 3H), 1.97(m, 2H), 1.84(m, 1H) |
| C1 | δ 8.50(d, J=5.0Hz, 1H), 8.24(s, 1H), 7.73(s, 1H), 7.61(dd, J=1.5, 5.0Hz, 1H), 7.50(bs, 1H), |
| | 7.29(s, 1H), 4.95(m, 1H), 2.83(t, J=6.5Hz, 2H), 2.75(m, 1H), 2.32(s, 3H), 1.97(m, 2H), 1.69 |
| | (m, 1H) |
| C2 | δ 8.24(s, 1H), 7.37(bs, 1H), 7.29(m, 2H), 7.05(s, 1H), 4.91(m, 1H), 3.96(s, 3H), 2.82(t, J=6.4Hz, |
| | 2H), 2.73(m, 1H), 2.32(s, 3H), 1.95(m, 2H), 1.65(m, 1H) |

(d)-doublet,
(t)-triplet,
(q)-quartet,
(m)-multiplet,
(dd)-doublet of doublets,
(dt)-doublet of triplets,
(br s)-broad singlet.

### BIOLOGICAL EXAMPLES OF THE INVENTION

General protocol for preparing test suspensions: Test compounds are first dissolved in acetone in an amount equal to 3% of the final volume and then suspended at the desired concentration (in ppm) in acetone and purified water (50/50 mix) containing 250 ppm of the surfactant Trem® 014 (polyhydric alcohol esters). The resulting test suspensions are then used in the following tests. Spraying a 200 ppm test suspension to the point of run-off on the test plants is the equivalent of a rate of 500 g/ha

### Test A

The test suspension was sprayed to the point of run-off on wheat seedlings. The following day the seedlings were inoculated with a spore dust of Erysiphe graminis f sp. tritici, (the causal agent of wheat powdery mildew) and incubated in a growth chamber at 20° C. for 7 days, after which disease ratings were made.

### Test B

The test suspension was sprayed to the point of run-off on wheat seedlings. The following day the seedlings were inoculated with a spore suspension of Puccinia recondita (the causal agent of wheat leaf rust) and incubated in a saturated atmosphere at 20° C. for 24 hours, and then moved to a growth chamber at 20° C. for 6 days, after which disease ratings were made.

### Test C

The test suspension was sprayed to the point of run-off on tomato seedlings. The following day the seedlings were inoculated with a spore suspension of Phytophthora infestans (the causal agent of potato and tomato late blight) and incubated in a saturated atmosphere at 20° C. for 24 hours, and then moved to a growth chamber at 20° C. for 5 days, after which disease ratings were made.

### Test D

The test suspension was sprayed to the point of run-off on grape seedlings. The following day the seedlings were inoculated with a spore suspension of Plasmopara viticola (the causal agent of grape downy mildew) and incubated in a saturated atmosphere at 20° C. for 24 hours, moved to a growth chamber at 20° C. for 6 days, and then incubated in a saturated atmosphere at 20° C. for 24 hours, after which disease ratings were made.

Results for Tests A-D are given in Table A. In the table, a rating of 100 indicates 100% disease control and a rating of 0 indicates no disease control (relative to the controls). A dash (-) indicates no test results. ND indicates disease control not determined due to phytotoxicity.

TABLE A

| Compound | Test A | Test B | Test C | Test D |
|---|---|---|---|---|
| A1 | 0 | 84 | 100 | — |
| A2 | 0 | 18 | 5 | — |
| A3 | 0 | 41 | 47 | — |
| A4 | 0 | 0 | 90 | — |
| A5 | 0 | 55 | 46 | — |
| A6 | 0 | 9 | 82 | — |
| A7 | 0 | 45 | 75 | — |
| A8 | 0 | 55 | 100 | — |
| A9 | 0 | 38 | 97 | — |
| A10 | — | — | — | — |
| B1 | 0 | 19 | 16 | — |
| B2 | — | — | — | — |
| B3 | 0 | 23 | 56 | — |
| B4 | 0 | 9 | 32 | — |
| B5 | — | — | — | — |
| B6 | — | — | — | — |
| B7 | — | — | — | — |
| B8 | 0 | 19 | 47 | — |
| C1 | 0 | 55 | 84 | — |
| C2 | 95 | 28 | 18 | — |

What is claimed is:

1. A method for controlling plant diseases caused by fungal plant pathogens comprising applying to the plant or portion thereof, or to the plant seed or seedling, a fungicidally effective amount of a compound of Formula 1, N-oxides, agriculturally suitable salts and compositions thereof: 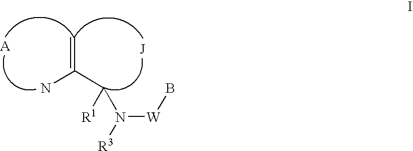
wherein
A is taken together with N—C═C to form a substituted fused pyridinyl ring;
B is a substituted phenyl or pyridinyl ring;
J is an optionally substituted linking chain of 2 to 5 members including at least one carbon member, optionally including one or two carbon members as C(═O), and optionally including one member selected from nitrogen and oxygen;
W is C=L or SOₙ;
L is O or S;
R¹ is H; or C₁-C₆ alkyl, C₂-C₆ alkenyl, C₂-C₆ alkynyl or C₃-C₆ cycloalkyl, each optionally substituted;
R³ is H; or C₁-C₆ alkyl, C₂-C₆ alkenyl, C₂-C₆ alkynyl or C₃-C₆ cycloalkyl, C₂-C₆ alkylcarbonyl, C₂-C₆ alkoxycarbonyl, C₂-C₆ alkylaminocarbonyl or C₃-C₈ dialkylaminocarbonyl; and
n is 1 or 2.

2. The method of claim 1 wherein
A is taken together with N—C═C to form a fused pyridinyl ring substituted with one or two substituents independently selected from R⁵;
B is substituted with from one to three substituents independently selected from R⁶;
J is a linking chain of 2 to 5 members including at least one carbon member, optionally including one or two carbon members as C(═O), and optionally including one member selected from nitrogen or oxygen, optionally substituted with one or more substituents selected from the group consisting of C₁-C₂ alkyl, halogen, CN, NO₂ and C₁-C₂ alkoxy;
R¹ is H; or C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylamino and C₃-C₆ cycloalkylamino;
each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl C₃-C₆ halocycloalkyl halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or
each R⁵ and each R⁶ is independently a phenyl ring, a 5- or 6-membered heteroaromatic ring, a benzyl ring or a phenoxy ring, each ring optionally substituted with from one to three groups independently selected from R⁷; and
each R⁷ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl C₁-C₄ alkoxycarbonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl.

3. The method of claim 2 wherein
W is C═O;
J is selected from —CH₂CH₂—, —CH₂CH₂CH₂—, —CH₂CH₂CH₂CH₂—, —OCH₂—, —OCH₂CH₂—, —OCH₂CH₂CH₂—, —CH₂NHCH₂—, —CH₂N(C₁-C₂alkyl)CH₂—, —CONHCO— and —CON(C₁-C₂ alkyl)CO—; and
each R⁵ and each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl C₁-C₄ haloalkylsulfonyl, C₁-C₄ alkoxycarbonyl, C₂-C₆ alkylcarbonyl, C₂-C₆ alkoxycarbonyl, C₂-C₆ alkylaminocarbonyl or C₃-C₈ dialkylaminocarbonyl.

4. The method of claim 3 wherein
B is a phenyl ring optionally substituted with from one to three substituents independently selected from R⁶;
J is —CH₂CH₂— or —CH₂CH₂CH₂—;
each R⁵ is independently CH₃, Cl, Br, I, CN, NO₂, CF₃, OCF₃, OCHF₂, SCF₃, SCHF₂, CO₂CH₃ or CONHCH₃; and
each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

5. The method of claim 3 wherein
B is a 3-pyridinyl or a 4-pyridinyl ring optionally substituted with from one to three substituents independently selected from R⁶;
J is —CH₂CH₂— or —CH₂CH₂CH₂—;
each R⁵ is independently CH₃, Cl, Br, I, CN, NO₂, CF₃, OCF₃, OCHF₂, SCF₃, SCHF₂, CO₂CH₃ or CONHCH₃; and
each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

6. The method of claim 5 wherein B is a 3—pyridinyl ring wherein one R⁶ is Cl located at the 2-position ortho to the link with C═O, another R⁶ is selected from Cl or methyl and is located at the 4-position ortho to the link with C═O and a third optional R⁶ is methyl at the 6-position.

7. The method of any of claims 1 through 6 wherein R¹ is H and R³ is H.

8. The method of claim 1 comprising a compound selected from the group consisting of
2-chloro-6-methoxy-N-(5,6,7,8-tetrahydro-3-methyl-8-quinolinyl)-4-pyridinecarboxamide,
2,6-dichloro-N-(5,6,7,8-tetrahydro-3-methyl-8-quinolinyl)benzamide and
2,3,6-trifluoro-N-(5,6,7,8-tetrahydro-3-methyl-8-quinolinyl)benzamide.

9. A compound of Formula I of claim 1, N-oxides, agriculturally suitable salts thereof, provided that when B is a substituted phenyl ring, W is C═O or SO₂, R³ is H and J is a saturated chain of from 2 to 4 carbons that is either unsubstituted or substituted with from one to three substituents selected from the group consisting of alkyl, alkoxy, aryl or aralkyl, then the compound is an N-oxide.

10. The compound of claim 9 wherein
A is taken together with N—C═C to form a fused pyridinyl ring substituted with one or two substituents independently selected from R⁵;
B is substituted with from one to three substituents independently selected from R⁶;
J is a linking chain of 2 to 5 members including at least one carbon member, optionally including one or two carbon members as C(═O), and optionally including one member selected from nitrogen or oxygen, optionally substituted with one or more substituents selected from the group consisting of C₁-C₂ alkyl halogen, CN, NO₂ and C₁-C₂ alkoxy;
R¹ is H; or C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylamino and C₃-C₆ cycloalkylamino;
each R⁵ and each R⁶ is independently C₁-C₆ alkyl C₂-C₆ alkenyl, Q-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or
each R⁵ and each R⁶ is independently a phenyl ring, a 5- or 6-membered heteroaromatic ring, a benzyl ring or a phenoxy ring, each ring optionally substituted with from one to three groups independently selected from R⁷; and
each R⁷ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl C₁-C₄ alkoxycarbonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl.

11. The compound of claim 10 wherein
W is C═O;
J is selected from —CH₂CH₂—, —CH₂CH₂CH₂—, —CH₂CH₂CH₂CH₂—, —OCH₂—, —OCH₂CH₂—, —OCH₂CH₂CH₂—, —CH₂NHCH₂—, —CH₂N(C₁-C₂alkyl)CH₂—, —CONHCO— and —CON(C₁-C₂ alkyl)CO—; and
each R⁵ and each R⁶ is independently C₁-C₆ alkyl, C₂-C₆ alkenyl, C₂-C₆ alkynyl C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl C₁-C₄ alkoxycarbonyl, C₂-C₆ alkylcarbonyl C₂-C₆ alkoxycarbonyl C₂-C₆ alkylaminocarbonyl or C₃-C₈ dialkylaminocarbonyl.

12. The compound of claim 11 wherein
B is a phenyl ring optionally substituted with from one to three substituents independently selected from R⁶;
J is —CH₂CH₂— or —CH₂CH₂CH₂—;
each R⁵ is independently CH₃, Cl, Br, I, CN, NO₂, CF₃, OCF₃, OCHF₂, SCF₃, SCHF₂, CO₂CH₃ or CONHCH₃; and
each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

13. The compound of claim 11 wherein
B is a 3-pyridinyl or a 4-pyridinyl ring optionally substituted with from one to three substituents independently selected from R⁶;
J is —CH₂CH₂— or —CH₂CH₂CH₂—;
each R⁵ is independently CH₃, Cl, Br, I, CN, NO₂, CF₃, OCF₃, OCHF₂, SCF₃, SCHF₂, CO₂CH₃ or CONHCH₃; and
each R⁶ is independently C₁-C₂ alkyl, C₁-C₂ haloalkyl, halogen, CN, C₁-C₂ alkoxy, C₁-C₂ haloalkoxy, C₁-C₂ alkylthio, C₁-C₂ alkylsulfinyl or C₁-C₂ alkylsulfonyl and at least one R⁶ is located in a position ortho to the link with W.

14. The compound of claim 13 wherein B is a 3-pyridinyl ring wherein one R⁶ is Cl located at the 2-position ortho to the link with C═O, another R⁶ is selected from Cl or methyl and is located at the 4-position ortho to the link with C═O and a third optional R⁶ is methyl at the 6-position.

15. The compound of any of claims 9 through 14 wherein R¹ is H and R³ is H.

16. The compound of claim 9 that is 2-chloro-6-methoxy-N-(5,6,7,8-tetrahydro-3-methyl-8-quinolinyl)-4-pyridinecarboxamide.

17. A composition comprising (a) at least one compound of Formula I of claim 1; and
(b) at least one compound selected from the group consisting of
(b1)alkylenebis(dithiocarbamate) fungicides; (b2) compounds acting at the bc, complex of the fungal mitochondrial respiratory electron transfer site; (b3) cymoxanil; (b4) compounds acting at the demethylase enzyme of the sterol biosynthesis pathway; (b5) morpholine and piperidine compounds that act on the sterol biosynthesis pathway; (b6) phenylamide fungicides; (b7) pyrimidinone fungicides; (b8) phthalimides; and (b9) fosetyl-aluminum.

18. The composition of claim 19 wherein component (b) comprises at least one compound from each of two different groups selected from (b1), (b2), (b3), (b4), (b5), (b6), (b7), (b8) and (b9).
